(19) United States
(12) Patent Application Publication
(10) Pub. No.: US 2021/0331376 A1
(43) Pub. Date: Oct. 28, 2021

(54) SYSTEMS, METHODS, AND DEVICES FOR ACTUATION OF BUILD MATERIAL

(71) Applicant: Desktop Metal, Inc., Burlington, MA (US)

(72) Inventors: Aaron M. Preston, Arlington, MA (US); Charles J. Haider, Cambridge, MA (US); Paul Titchener, Cambridge, MA (US); Alexander C. Barbati, Melorse, MA (US); Nicholas Mykulowycz, Boxford, MA (US)

(73) Assignee: Desktop Metal, Inc., Burlington, MA (US)

(21) Appl. No.: 17/238,006

(22) Filed: Apr. 22, 2021

Related U.S. Application Data
(60) Provisional application No. 63/014,201, filed on Apr. 23, 2020.

(51) Int. Cl. B29C 64/118; B29C 64/209; B29C 64/321; B29C 64/232; B29C 64/241; B29C 64/236; B33Y 10/00

(52) U.S. Cl. CPC B29C 64/118; B29C 64/209; B29C 64/321; B33Y 10/00; B29C 64/241; B29C 64/236; B29C 64/232

(57) ABSTRACT

An actuation method comprising applying a force to a first rod of build material disposed within an actuation volume. The first rod of build material may include at least one metal. The method may further comprise moving the first rod of build material in a direction substantially parallel to or substantially coaxial with a longitudinal axis of the first rod of build material toward an extrusion head and loading a second rod of build material into the actuation volume. The second rod of build material may include at least one metal. A longitudinal axis of the second rod may be substantially coaxial with the longitudinal axis of the first rod. The applying step and the moving step may be repeated for the second rod of build material.

### CROSS-REFERENCE TO RELATED APPLICATION

The present application claims the benefit of U.S. Provisional Patent Application No. 63/014,201 entitled “Systems, Methods, and Devices for Actuation of Build Material” filed Apr. 23, 2020, the contents of which are incorporated herein by reference in their entirety.

### TECHNICAL FIELD

Various aspects of the present disclosure relate generally to systems and methods for fabricating components.

### BACKGROUND OF THE DISCLOSURE

Metal injection molding (MIM) is a metalworking process useful in creating a variety of metal objects. A mixture of powdered metal and one or more binders may form a “feedstock” capable of being molded, when heated, into the shape of a desired object. The initial molded part, also referred to as a “green part,” may then undergo a preliminary debinding process (e.g., chemical debinding or thermal debinding) to remove primary binder while leaving secondary binder intact, followed by a sintering process. During sintering, the part may be heated to vaporize and remove the secondary binder (thermal debinding) and brought to a temperature near the melting point of the powdered metal, which may cause the metal powder to densify into a solid mass, thereby producing the desired metal object.

Additive manufacturing, which includes three-dimensional (3D) printing, includes a variety of techniques for manufacturing a three-dimensional object via a process of forming successive layers of the object. Three-dimensional printers may in some embodiments utilize a feedstock comparable to that used in MIM, thereby creating a green part without the need for a mold. The printed green part may then undergo debinding and sintering processes to produce the object.

In order to form the successive layers of the object, feedstock may be driven through an extrusion head. It is desirable to exert a strong force on the feedstock, such as a rod of feedstock. It is also desirable to exert a constant force and to maintain stability of a feedstock during extrusion. For example, a force may exerted on an end surface of a rod in order to urge the rod toward the extrusion head. Current systems may not be compatible with rods of material, may fail to exert a strong enough or consistent enough force, or may include other problematic aspects.

The systems and methods of the current disclosure may address some of the deficiencies described above or may address other aspects of the prior art.

### SUMMARY OF THE DISCLOSURE

Examples of the present disclosure relate to, among other things, systems and methods for fabricating components using additive manufacturing. Each of the examples disclosed herein may include one or more of the features described in connection with any of the other disclosed examples.

The present disclosure includes, in one example, an actuation method comprising applying a force to a first rod of build material disposed within an actuation volume. The first rod of build material may include at least one metal. The method may further comprise moving the first rod of build material in a direction substantially parallel to or substantially coaxial with a longitudinal axis of the first rod of build material toward an extrusion head and loading a second rod of build material into the actuation volume. The second rod of build material may include at least one metal. A longitudinal axis of the second rod may be substantially coaxial with the longitudinal axis of the first rod. The applying step and the moving step may be repeated for the second rod of build material.

In another example, an actuation method may comprise using a body to apply a first force to a first rod of build material disposed within a first actuation volume. The first rod of build material may include at least one metal. The method may further comprise moving the first rod of build material in a direction substantially parallel to or substantially coaxial with a longitudinal axis of the first rod of build material toward an extrusion head; moving at least one of the body or the first actuation volume so that the at least one of the body or the first actuation volume does not intersect a longitudinal axis of the extrusion head; and using the body, applying a second force to a second rod of build material disposed within a second actuation volume. The second rod of build material may include at least one metal. The method may further comprise moving the second rod of build material in a direction substantially parallel to or substantially coaxial with the longitudinal axis of the second rod toward the extrusion head.

In another example, an actuation method may comprise simultaneously applying a first force to a first rod of build material and a second force to a second rod of build material. Each of the first rod and the second rod may include metal. The method may further comprise simultaneously moving the first rod along a longitudinal axis of the first rod and the second rod along a longitudinal axis of the second rod.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The terms “object,” “part,” and “component,” as used herein, are intended to encompass any object fabricated through the additive manufacturing techniques described herein.

It should be noted that all numeric values disclosed or claimed herein (including all disclosed values, limits, and ranges) may have a variation of +/−10% (unless a different variation is specified) from the disclosed numeric value. In this disclosure, unless stated otherwise, relative terms, such as, for example, “about,” “substantially,” and “approximately” are used to indicate a possible variation of +/−10% in the stated value. Moreover, in the claims, values, limits, and/or ranges of various claimed elements and/or features means the stated value, limit, and/or range +/−10%. As used herein, a z-axis may be an axis of extrusion of a component. Successive layers of a component may be formed along the z-axis.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1A is a block diagram of an additive manufacturing system according to some embodiments of the disclosure.

FIG. 1B illustrates an exemplary printing subsystem of the system of FIG. 1A.

FIG. 1C illustrates an exemplary debinding subsystem of the system of FIG. 1A.

FIG. 1D illustrates an exemplary furnace subsystem of the system of FIG. 1A.

FIGS. 2A-8B depict exemplary pushing actuation mechanisms.

FIGS. 9A and 9B depict exemplary actuation mechanisms utilizing pneumatics.

FIGS. 10A-18B depict exemplary gripping actuation mechanisms.

FIGS. 19-22 depict actuation mechanisms having rollers.

FIGS. 23A-25 depict exemplary actuation mechanisms having an inchworm movement.

FIGS. 26A-27D depict exemplary mechanisms that actuate rods of build material using helixes to achieve translational movement of the rods of build material.

FIGS. 28-35 depict aspects of mechanisms that actuate rods of build material using helixes to achieve rotational and translational movement of the rods of build material.

FIG. 36 depicts an actuation mechanism having a tap.

### DETAILED DESCRIPTION

Embodiments of the present disclosure include systems and methods to facilitate or improve the efficacy or efficiency of additive manufacturing. Reference now will be made in detail to examples of the present disclosure described above and illustrated in the accompanying drawings. Wherever possible, the same reference numbers will be used throughout the drawings to refer to the same or like parts.

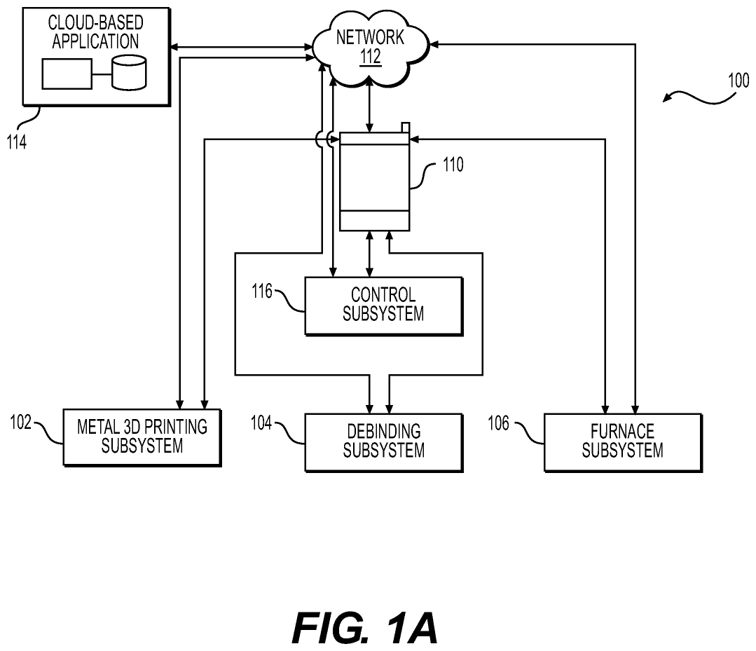

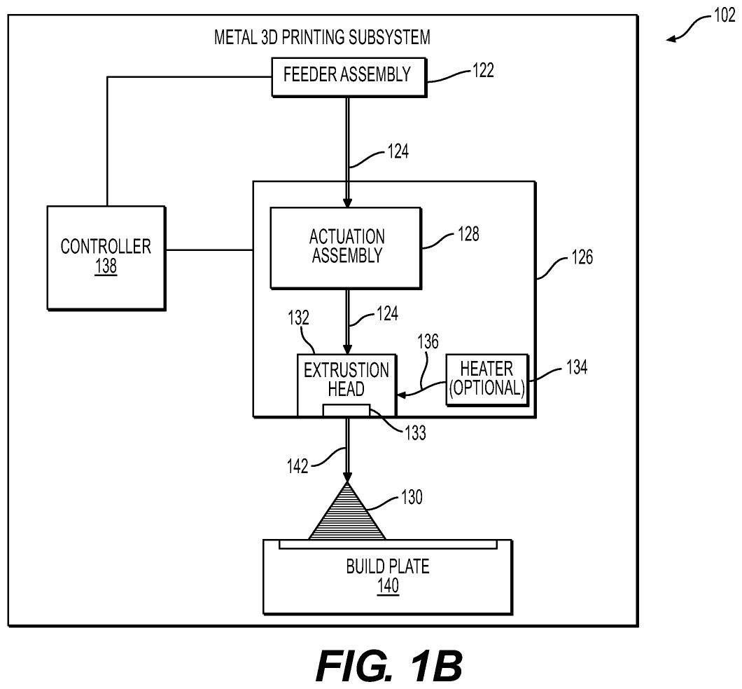

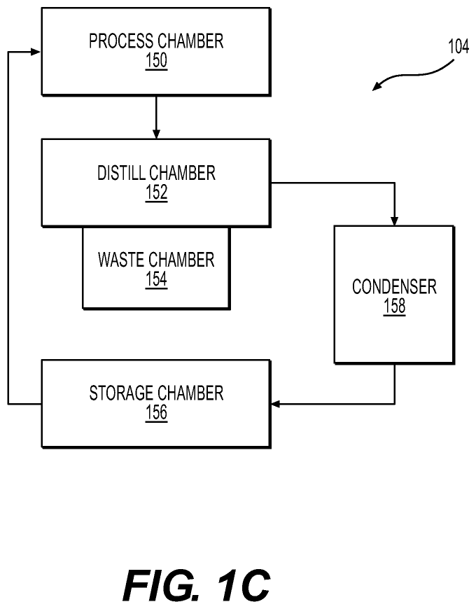

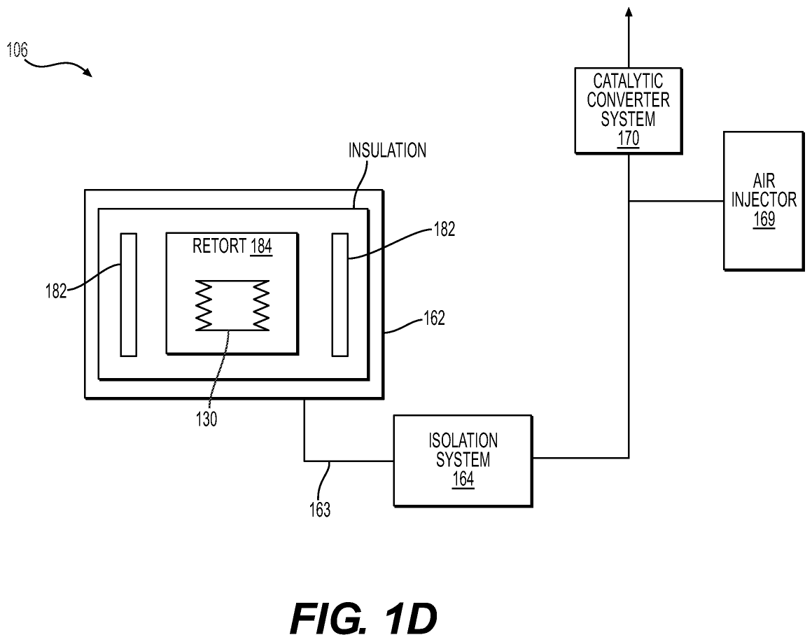

FIG. 1A illustrates an exemplary system 100 for forming a printed object, according to an embodiment of the present disclosure. System 100 may include a three-dimensional (3D) printer, for example, a metal 3D printing subsystem 102, and one or more treatment site(s), for example, a debinding subsystem 104 and a furnace subsystem 106, for treating the green part after printing. Metal 3D printing subsystem 102 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer such as polypropylene).

Debinding subsystem 104 may be configured to treat the printed object by performing a first debinding process, in which the primary binder material may be removed. In some embodiments, the first debinding process may be a chemical debinding process, as will be described in further detail with reference to FIG. 1C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 104 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 106, rather than a separate heating debinding subsystem 104, may be configured to perform the first debinding process. For example, the furnace subsystem 106 may be configured to heat the deposited build material to a temperature at or above the vaporization temperature of the primary binder material and below the vaporization temperature of the secondary binder material such that the primary binder material is removed from the deposited build material.

Furnace subsystem 106 may be configured to treat the printed object by performing a secondary thermal debinding process (or also a primary debinding process, as in the alternative embodiment described above), in which the secondary binder material and/or any remaining primary binder material may be vaporized and removed from the printed part. In some embodiments, the secondary debinding process may comprise a thermal debinding process, in which the furnace subsystem 106 may be configured to heat the part to a temperature at or above the vaporization temperature of the secondary binder material to remove the secondary binder material. The furnace subsystem 106 may then heat the part to a temperature just below the melting point of the metal powder to sinter the metal powder and to densify the metal powder into a solid metal part.

As shown in FIG. 1A, system 100 may also include a user interface 110, which may be operatively coupled to one or more components, for example, to metal 3D printing subsystem 102, debinding subsystem 104, and furnace subsystem 106, etc. In some embodiments, user interface 110 may be a remote device (e.g., a computer, a tablet, a smartphone, a laptop, etc.) or an interface incorporated into system 100, e.g., on one or more of the components. User interface 110 may be wired or wirelessly connected to one or more of metal 3D printing subsystem 102, debinding subsystem 104, and/or furnace subsystem 106. System 100 may also include a control subsystem 116, which may be included in user interface 110, or may be a separate element.

Metal 3D printing subsystem 102, debinding subsystem 104, furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., part geometries, printing material, one or more support and/or support interface details, printing instructions, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of metal 3D printing subsystem 102, debinding subsystem 104, sintering furnace subsystem 106, user interface 110, and/or control subsystem 116. In this aspect, metal 3D printing subsystem 102, debinding subsystem 104, furnace subsystem 106, user interface 110, and/or control subsystem 116 may be disconnected from the Internet and/or other networks, which may increase security protections for the components of system 100. In either aspect, an additional controller (not shown) may be associated with one or more of metal 3D printing subsystem 102, debinding subsystem 104, and furnace subsystem 106, etc., and may be configured to receive instructions to form the printed object and to instruct one or more components of system 100 to form the printed object.

FIG. 1B is a block diagram of a metal 3D printing subsystem 102 according to one embodiment. The metal 3D printing subsystem 102 may extrude build material 124 to form a three-dimensional part. As described above, the build material may include a mixture of metal powder and binder material. For example, the build material may include any combination of metal powder, plastics, wax, ceramics, polymers, among others. In some embodiments, the build material 124 may come in the form of a rod comprising a predetermined composition of metal powder and one or more binder components (e.g., a primary and a secondary binder).

Metal 3D printing subsystem 102 may include an extrusion assembly 126 comprising an extrusion head 132. Metal 3D printing subsystem 102 may include an actuation assembly 128 configured to move the build material 124 into the extrusion head 132. For example, the actuation assembly 128 may be configured to move a rod of build material 124 into the extrusion head 132. In some embodiments, the build material 124 may be continuously provided from the feeder assembly 122 to the actuation assembly 128, which in turn may move the build material 124 into the extrusion head 132. In some embodiments, the actuation assembly 128 may employ a linear actuation to continuously grip or push the build material 124 from the feeder assembly 122 towards the extrusion head 132.

In some embodiments, the metal 3D printing subsystem 102 includes a heater 134 configured to generate heat 136 such that the build material 124 moved into the extrusion head 132 may be heated to a workable state. In some embodiments, the heated build material 124 may be extruded through a nozzle 133 to extrude workable build material 142 onto a build plate 140. It is understood that the heater 134 is an exemplary device for generating heat 136, and that heat 136 may be generated in any suitable way, e.g., via friction of the build material 124 interacting with the extrusion assembly 126, in alternative embodiments. While there is one nozzle 133 shown in FIG. 1B, it is understood that the extrusion assembly 126 may comprise more than one nozzle in other embodiments. In some embodiments, the metal 3D printing subsystem 102 may include another extrusion assembly (not shown in FIG. 1B) configured to extrude a non-sintering ceramic material onto the build plate 140.

In some embodiments, the metal 3D printing subsystem 102 comprises a controller 138. The controller 138 may be configured to position the nozzle 133 along an extrusion path (also referred to as a toolpath) relative to the build plate 140 such that the workable build material is deposited on the build plate 140 to fabricate a three-dimensional printed object 130. The controller 138 may be configured to manage operation of the metal 3D printing subsystem 102 to fabricate the printed object 130 according to a three-dimensional model. In some embodiments, the controller 138 may be remote or local to the metallic printing subsystem 102. The controller 138 may be a centralized or distributed system. In some embodiments, the controller 138 may be configured to control a feeder assembly 122 to dispense the build material 124. In some embodiments, the controller 138 may be configured to control the extrusion assembly 126, e.g., the actuation assembly 128, the heater 134, the extrusion head 132, or the nozzle 133. In some embodiments, the controller 138 may be included in the control subsystem 116.

FIG. 1C depicts a block diagram of a debinder subsystem 104 for debinding a printed object 130 according to one embodiment. The debinder subsystem 104 may include a process chamber 150, into which the printed object 130 may be inserted for a first debinding process. In some embodiments, the first debinding process may be a chemical debinding process. In such embodiments, the debinder subsystem 104 may include a storage chamber 156 to store a volume of debinding fluid, e.g., a solvent, for use in the first debinding process. The storage chamber 156 may comprise a port which may be used to fill, refill, and/or drain the storage chamber 156 with the debinding fluid. In some embodiments, the storage chamber 156 may be removably attached to the debinder subsystem 104. In such embodiments, the storage chamber 156 may be removed and replaced with a replacement storage chamber (not shown in FIG. 1C) to replenish the debinding fluid in the debinding subsystem 104. In some embodiments, the storage chamber 156 may be removed, refilled with debinding fluid, and reattached to the debinding subsystem 104.

The debinding fluid contained in the storage chamber 156 may be directed to the process chamber 150 containing the inserted printed object 130. In some embodiments, the build material that the printed object 130 is formed of may include a primary binder material and a secondary binder material. The printed object 130 in the process chamber 150 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 152. For example, after the first debinding process, the process chamber 150 may be drained of the used debinding fluid, and the used debinding fluid may be directed to the distill chamber 152. In some embodiments, the distill chamber 152 may be configured to distill the used debinding fluid. In some embodiments, the debinding subsystem 104 may further include a waste chamber 154 fluidly coupled to the distill chamber 152. In such embodiments, the waste chamber may collect waste accumulated in the distill chamber 152 as a result of the distillation. In some embodiments, the waste chamber 154 may be removably attached to the debinding subsystem 104 such that the waste chamber 154 may be removed and emptied or replaced after one or more distillation cycles. In some embodiments, the debinding subsystem 104 may include a condenser 158 configured to condense vaporized used debinding fluid from the distill chamber 152 and return the debinding fluid back to the storage chamber 156.

FIG. 1D is a block diagram of the furnace subsystem 106 according to exemplary embodiments. The furnace subsystem 106 may include one or more of a furnace chamber 162, an isolation system 164, an air injector 169 (also referred to as an oxygen injector, which may introduce air or oxygen gas into the system), and a catalyst converter system 170.

The furnace chamber 162 may be a sealable and insulated chamber designed to enclose a controlled atmosphere substantially free of oxygen to prevent combustion. In the context of the current disclosure, a controlled atmosphere refers to an atmosphere being controlled for one or more of temperature, composition, and pressure. The furnace chamber 162 may include one or more heating elements 182 for heating the atmosphere enclosed within the furnace chamber 162. As shown in FIG. 1D, the printed object 130 may be placed in the furnace chamber 162 for thermal processing. e.g., a thermal debinding process or a densifying process. In some embodiments, the furnace chamber 162 may be heated to a suitable temperature as part of the thermal debinding process in order to degrade any binder components included in the printed object 130 and then may be heated to just below a sintering temperature to densify the part. The furnace chamber 162 may include heat-conductive walls (e.g., graphite walls) to spread heat generated by the heating elements 182 within the furnace chamber 162, thereby enhancing temperature uniformity in a region where the printed object 130 is located. The furnace chamber 162 may include a retort 184 with walls partially or fully enclosing the region where the printed object 130 is located. In some embodiments, the furnace chamber 162, specifically the retort 184, may include one or more shelves on which the printed object 130 may be placed within the furnace chamber 162.

Gaseous effluent may be released into the atmosphere of the furnace chamber 162 as the printed object 130 is heated during a thermal processing, e.g., during the thermal debinding process. In some embodiments, the gaseous effluent may be pumped out of the furnace chamber 162, flowed through the isolation system 164, and directed towards the catalyst converter system 170. The isolation system 164 may be configured to prevent downstream fluid (e.g., gas, particularly oxygen gas from air injector 169) from flowing back towards the furnace chamber 162. The isolation system 164 or catalytic converter system 170 may be configured to remove at least a portion of the toxic fumes, e.g., at least a portion of the volatilized binder components, from the gaseous effluent.

Rods of build material 142 may be approximately 150 mm long (and may range from between approximately 60 mm to approximately 300 mm), with a circular cross-section having a diameter of approximately 6.0 mm (and may range from between approximately 1.5 mm to approximately 10 mm). Cross sectional diameter may be tightly controlled to maximize deposition accuracy. A smallest possible diameter of rod of build material 142 may be limited by a material strength of rod of build material 142, and a largest diameter of rod of build material 142 may be limited by a desired printing resolution (which may relate to orifice size and actuator resolution). A cross-sectional shape of rod of build material 142 may be circular or may be any shape, including but not limited to, round, oval, any polygonal shape (triangular, quadrilaterals, pentagons, hexagons, etc.), kidney bean, hollow (annular, box), I-beam, T-beam, and/or centroid outside of perimeter (L-beam, U-beam). Cross-sectional shape and/or size may change along a longitudinal axis of rod of build material 142, or may remain constant.

An outer surface of rod of build material 142 may be smooth, rough (e.g., for encouraging friction), and/or include surface features such as indentations and/or protrusions that may be used to interact with an element for driving the rod (e.g., gearing). Surfaces of ends of rod of build material 142 may be smooth and/or include surface features (e.g., to encourage alignment and/or coupling between the rods). Exemplary surface features may include conical features to facilitate alignment, and/or anti-tampering features to encourage coupling by transfering rotation across rods.

For a given formulation, a temperature of rod of build material 142 may be held at a temperature which is below the softening point of all materials in the composition. This may maximize the amount of force which can be applied to the rod before failure (yielding, buckling, etc.).

The actuation assemblies described herein my share certain features or qualities. For example, each of the actuation assemblies may actuate rod of build material 142 along its longitudinal axis (along the z-axis). Each of the assemblies facilitate reloading of additional rods of build material 142. Where a new rod of build material 142 is reloaded following extrusion of a previous rod of build material 142, the new rod of build material 142 may have a longitudinal axis that is substantially coaxial with a longitudinal axis of the previous rod of build material 142. The assemblies may provide support for rods of build material 142 during actuation. The assemblies may also include features that relieve pressure. In some examples, more than one rod of build material 142 may be extruded at once. In such examples, each rod of build material 142 may have substantially parallel longitudinal axes.

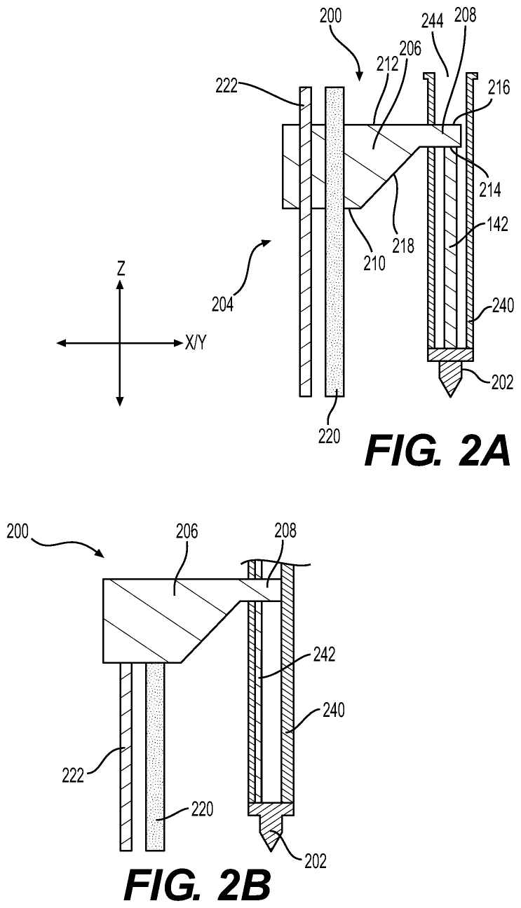

FIGS. 2A and 2B show an exemplary extrusion assembly 200, which may have any of the properties of extrusion assembly 126, described above. FIG. 2A shows a cross-sectional view of extrusion assembly 200, and FIG. 2B shows a perspective view of extrusion assembly 200. Extrusion assembly 200 may include an extrusion head 202. Extrusion head 202 may be configured to extrude a rod of build material 142 according to a specification. Build material 142 may be extruded along an extrusion axis, which may be along the z-axis.

Extrusion assembly 200 may also include an actuation assembly 204, which may have any of the qualities of actuation assembly 128. Actuation assembly 204 may include a body 206 with a protrusion 208 extending therefrom. Body 206 may have a first surface 210 that is proximalmost to extrusion head 202 along the z-axis. Body 206 may have a second surface 212 that is distalmost from extrusion head 202 along the z-axis. First surface 210 and second surface 212 may be parallel or approximately parallel to one another.

Protrusion 208 may be a finger extending from body 206 and may be movable relative to body 206. Protrusion 208 may have a pushing surface 214 that may be configured to exert a force on a rod of build material 142. Pushing surface 214 may be configured to directly contact a rod of build material 142 or may be configured to contact a rod of build material 142 via intermediary structures. Protrusion 208 may include a surface 216 that may be aligned or approximately aligned along the z-axis with second surface 212 while pushing surface 214 contacts and exerts a force on a rod of build material 142. Pushing surface 214 may be further from extrusion head 202 along the z-axis than first surface 210 is. In other words, first surface 210 may be more proximate to extrusion head 202 than pushing surface 214 is, along the z-axis. Either body 206 or protrusion 208 may include a transverse surface 218 between first surface 208 and pushing surface 214. Alternatively, either body 206 or protrusion 208 may have a step portion (not shown) between first surface 208 and pushing surface 214.

Body 206 and protrusion 208 may be configured to move in a z-direction, proximally and distally relative to extrusion head 202. Protrusion 208 may move in both directions along the z-axis for at least a maximum length of a single rod of build material 142. For example, actuation assembly 204 may include a lead screw 220 or other device that may enable body 206 and protrusion 208 to move along lead screw 220 in, for example, a linear pattern. Linear motion may be provided by a ball screw, solenoid, linear motor, pneumatic/hydraulic piston, or any other suitable structure. Body 206 may include a nut (not shown) or other mechanism that is configured to interact with lead screw 220 in order to effectuate movement of body 206. Actuation assembly 204 may also include one or more guides 222, which may facilitate movement of body 206 without rotation or other undesired movement of body 206. For example, guide 222 may include a linear rail. Guide 222 may extend along an entirety of a range of travel of body 206.

As body 206 and protrusion 208 move in a negative z-direction (proximally toward extrusion head 202), pushing surface 214 may exert a force on a rod of build material nalong a negative Z-direction. Protrusion 208 and body 206 may move together as a rigid body as body 206 moves in a negative Z-direction.

Extrusion assembly 200 may also include a guide channel 240. Guide channel 240 may extend parallel or coaxial with an extrusion axis of extrusion head 202 (along the z-axis). Guide channel 240 may include surfaces that have a complementary shape to a rod of build material. For example, interior surfaces of guide channel 240 may be rounded. For example, interior surfaces of guide channel 240 may define a tubular shape or an approximately tubular shape. A longitudinal dimension of guide channel 240 may be greater than a length of a rod of build material. An internal diameter of guide channel 240 may be slightly larger than a diameter of a rod of build material so that the rod of build material 142 may translate relative to guide channel 240. However, a diameter of guide channel 240 may be sufficiently small such that guide channel 240 serves to constrain the rod of build material and maintain the rod so that a central longitudinal axis of the rod is coaxial or approximately coaxial with the extrusion axis.

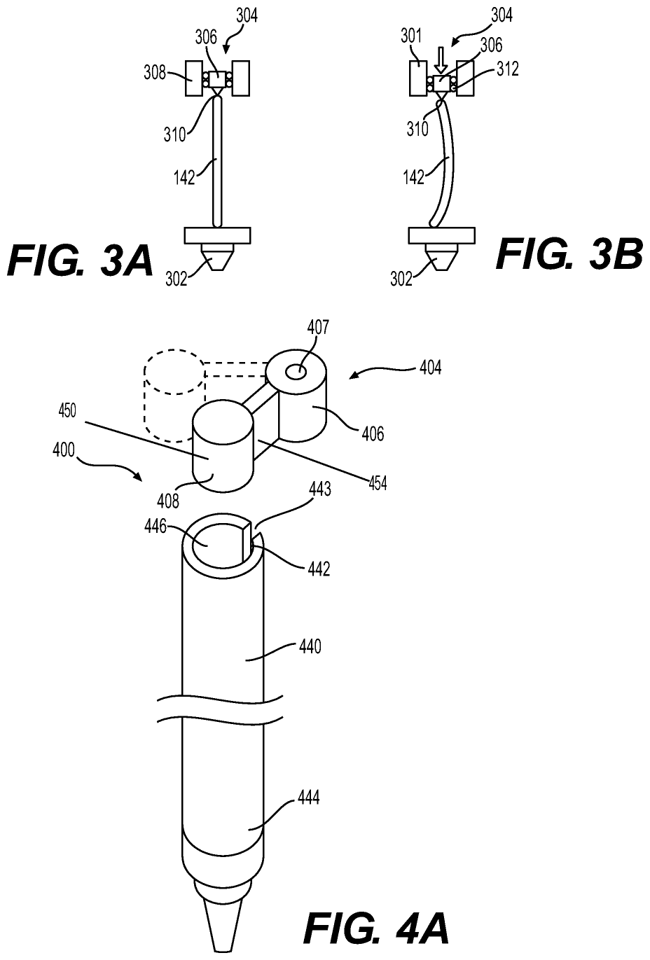

Guide channel 240 may prevent or limit buckling or bending of build material 142 that may occur absent the presence of guide channel 240 or an alternative structure. For example, as shown in FIG. 3A, a rod of build material 142 may be arranged such that a pushing surface 310 of an actuation assembly 304 contacts an end of the rod of build material 142 furthest from an extrusion head 302. Actuation assembly 304 is shown as including a body 306, two surfaces 308 on opposite sides of body 306, and ball bearings 312, between body 306 and surfaces 308. When pushing surface 310 is moved closer to extrusion head 302, as shown in FIG. 3B, pushing surface 310 may exert a force on the rod of build material 142 in the same direction as the motion of pushing surface 310. Absent a feature such as guide channel 240, the rod of build material 342 may bend or buckle radially, rather than moving longitudinally relative to an axis of the rod of build material 14/and or extrusion head 302. For example, a load with an eccentricity even of less than 0.25 mm (the force being applied off axis) may generate lateral deflection of greater than 1 mm under appreciable loads.

As shown in FIG. 2B, guide channel 240 may define one or more slots 242 extending from an interior surface of guide channel 240 to an exterior surface of guide channel 240. Slot 242 may be configured such that at least a portion of protrusion 208 may be received within slot 242. Thus, as body 206 moves proximally and distally toward extrusion head 202, body 206 may be external to guide channel 240, while protrusion 208 extends into guide channel 240 so that pushing surface 210 may exert a force along a longitudinal axis of the rod of build material. Alternatively, another portion of actuation assembly 204, such as a portion of body 206, may be received within slot 242. Alternatively, guide channel 240 may also be omitted and/or another mechanism may be used to align rod of build material 142 along a desired axis (e.g., a z-axis).

Rods of build material 142 may be loaded into an open end 244 of guide channel 240 when guide channel 240 is empty of another rod of build material 142, which may be at an end of guide channel 240 that is farthest from extrusion head 202. Therefore, a portion of actuation assembly 204 (e.g., protrusion 208) that extends into guide channel 240 (or otherwise intersects a rod of build material 142 as rod of build material 142 is pushed toward extrusion head 202) may need to move to a reload position in which actuation assembly 204 does not intersect the area in which a rod of build material 142 is to be received. For example, as described herein, protrusion 208 may move relative to body 206 in order to transition actuation assembly 204 into a configuration for loading a new rod of build material 142. Alternatively, an entirety of actuation assembly 204 (including body 206 and protrusion 208) may move. For example, actuation assembly may rotate about an axis in the z-direction. In such an example, actuation assembly 204 may disengage from any guide(s) 222 by moving along lead screw 220 in a z-direction away from extrusion head 202 past an end of guide(s) 222 that is furthest from extrusion head 202. Then, actuation assembly 204 may be rotated using, for example, a camming surface.

In the examples described herein, guide tube 240 may be reloaded with a new rod of build material 142 by a variety of mechanisms. For example, guide tube 240 may move relative to a fixed body 20 to facilitate reloading. For example, guide tube 240 may move laterally, longitudinally, or may pivot. Alternatively, guide tube 240 may split like a clamshell (into two halves) while rod of build material 142 is reloading laterally. Alternatively, guide tube 240 may rotate, and a new rod of build material 142 may enter laterally through a channel in guide tube 240. Guide tube 240 may also telescope to have a shorter longitudinal dimension for reloading. Additionally or alternatively, body 206 may move. For example, body 206 may rotate about any one or more of the x-, y-, or z-axes. Alternatively or additionally, body 206 may translate linearly along the x- and/or y-axis. Some of these example mechanisms will be described in further detail herein.

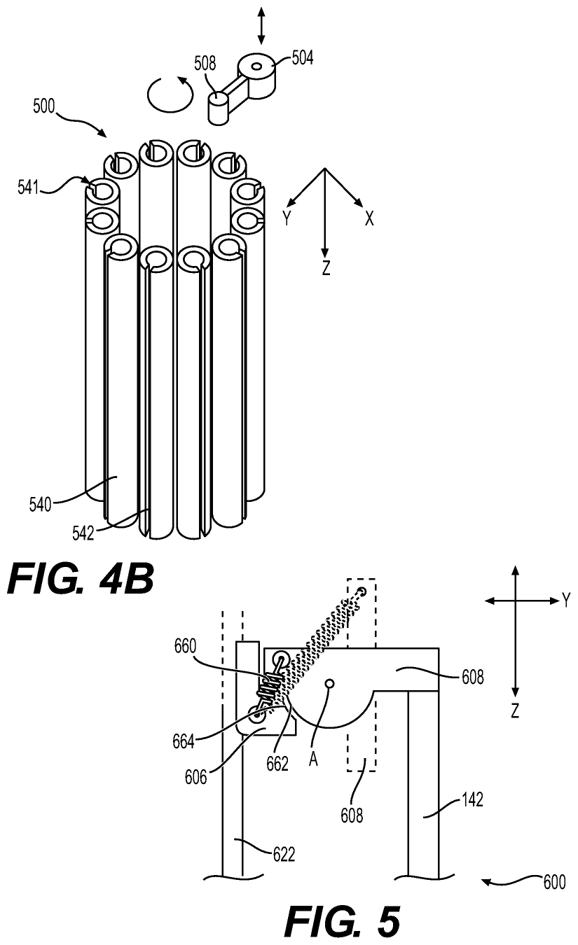

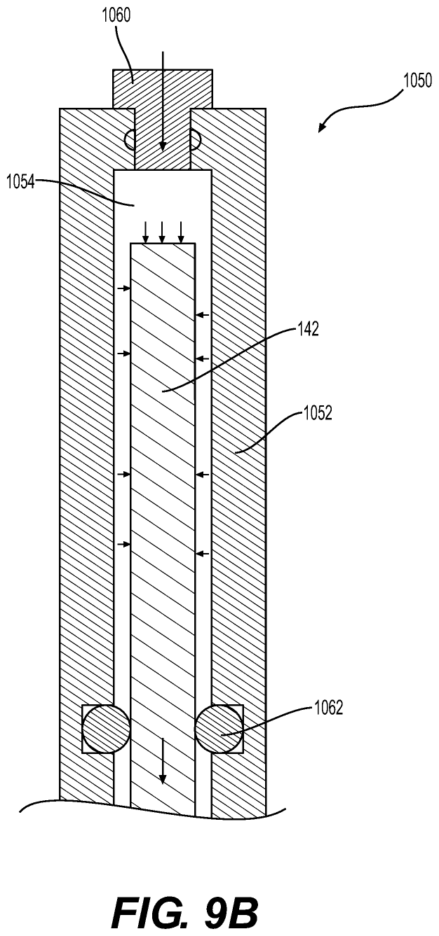

FIGS. 4A-8B illustrate aspects of systems utilizing pushing to extrude rods of build material 142. The examples in FIGS. 4A-8B may make use of any of the features of FIGS. 1A-3B, described above, and may be used in conjunction with at least some of those features. The examples of FIGS. 4A-8B also include features which may be used in conjunction with one another; the examples are not mutually exclusive. For example, the principles described herein may also apply to the assembly of FIG. 9A, described in further detail below

FIG. 4A shows an exemplary system 400 for allowing loading of a new rod of build material 142. System 400 may include an actuation assembly 404, which may include a body 406 and a protrusion 408. System 400 may also include a guide channel 440, which may define a slot 442. Although FIG. 4A shows a guide channel 440, it will also be appreciated that system 400 may not include guide channel 440. Guide channel may have a first end 444 and a second end 446. First end 444 may be closer to an extrusion head 402 than second end 446 is. Slot 442 may terminate in an opening 443 at second end 446.

Actuation assembly 404 may have any of the features or shapes described above with regard to actuation assembly 404. Additionally or alternatively, actuation assembly 404 may have one or more of the features described below.

Body 406 may have any suitable shape, including a cylindrical shape, a prism shape, a tubular shape, a share shape, a rectangular shape, an irregular shape, etc. Body 406 may also be mounted on guide(s) or lead screw(s) (not shown), which may have any of the features of guide 222 or lead screw 224. Alternatively, body 406 may be coupled to another portion that may be mounted on guides or lead screws.

Protrusion 408 may include a first portion 450 and a bridge portion 454. Bridge portion 454 may extend between body 406 and first portion 450. First portion 450 may have any suitable shape, including the shapes listed above with respect to body 406. As shown in FIG. 4A, first portion 450 may have a cylindrical shape. Bridge portion 454 may be sized so as to be received within slot 442. When bridge portion 454 is received within slot 442, first portion 450 may be disposed within guide channel 440.

First portion 450 and body 406 may be wider than bridge portion 454. A larger size of first portion 450 may increase a surface area of a pushing surface 414 that is configured to contact rod of build material 142. Although first portion 450 and body 406 are shown as having similar or the same sizes, first portion 450 and body 406 may have different sizes. For example, one of first portion 450 or body 406 may be larger along an X, Y, or Z-direction.

Body 406 may be rotatable about an axis 407. Rotation of body 406 may cause protrusion 408 to move about a perimeter of a circle. FIG. 4A shows a first example position of body 406 and finger 408 in solid lines and a second example position of body 406 and finger 408 in dashed lines. When bridge portion 454 is received within slot 442, protrusion 408 may be considered to be in a zero-degree position. Protrusion 408 may be rotatable along an entirety of a 360 degree path or for only a subset of a 360 degree path. For example, protrusion 408 may be rotatable in one or both of a first direction and/or a second, opposite direction.

When bridge portion 454 is received within slot 442, walls of guide channel 440 may prevent protrusion 408 and/or body 406 from rotating. When it is time to load a new rod of build material 142 into actuation assembly 404, protrusion 408 may move in the positive z-direction past second end 446 of guide channel 440 so that bridge portion 454 disengages from guide slot 442 (e.g., as shown in solid lines in FIG. 4A). After bridge portion 454 is past second end 446 of guide channel 440, protrusion 408 may be able to rotate relative to body 406 (e.g., as shown in dashed lines in FIG. 4A). For example, protrusion 408 may be biased so that protrusion 408 is at an angle other than zero degrees relative to body 406. Protrusion 408 may move (e.g., rotate) a sufficient amount so that protrusion 408 (e.g., first portion 450 of protrusion 408) does not intersect an axis along which the rod of build material 142 will be received in guide channel 440. In other words, protrusion 408 may be able to move a sufficient amount so that protrusion 408 does not interfere with loading of the rod of build material 142 into second end 446 of guide channel 440.

A variety of mechanisms may be used to effect rotation of protrusion 408. When protrusion 408 is not constrained by slot 442, protrusion 408 may transition to the biased angle of protrusion 408. Additionally or alternatively, a variety of actuation assemblies may be utilized to rotate protrusion 408. For example, cams, magnets, motors, or other mechanisms may be utilized.

After the rod of build material 142 is loaded, so that protrusion 408 may exert a force on the rod of build material 142 toward extrusion head 402 (in the negative z-direction), protrusion 408 may be transitioned into the configuration in which bridge portion 454 (or another portion) of protrusion 408 is received within slot 442 and intersects a longitudinal axis of the rod of build material 142. Body 406 and protrusion 408 may move toward extrusion head 402 (in the negative Z-direction), and a surface of protrusion 408 may exert a force on rod of build material 142 to push rod of build material 142 toward extrusion head 402 so as to extrude the build material. After body 406 has moved a predetermined amount in the negative Z-direction, body 406 may again move away from extrusion head 402 to permit reloading of another rod of build material 142.

FIG. 4B shows another exemplary system 500 for allowing loading of a new rod of build material. System 500 may make use of any of the features of system 400, including features of body 406 and protrusion 408. System 500 may also make use of any of the features of extrusion assembly 200, including body 206 and protrusion 208. System 500 may include a plurality of guide channels 540, which may have any of the properties of guide channels 240, 440, above. Each of guide channels 540 may define a slot 542 extending longitudinally along guide channel 540. FIG. 4B depicts that system 500 includes 12 guide channels 540. However, it will be appreciated that any suitable number of guide channels may be used.

Guide channels 540 may be arranged in a rotatable drum 541. Drum 541 may be rotatable about a central axis that is parallel to longitudinal axes of guide channels 540. Guide channels may be arranged circumferentially about drum 541. As drum 541 rotates about its central axis, guide channels 540 may sequentially be aligned with a protrusion 508 so that protrusion 508 pushes on an end of a rod of build material (not shown in FIG. 4B) loaded in guide channel 540, via slot 542. Protrusion 508 may extend from a body 506, and body 506/protrusion 508 may have any of the features of body 406/protrusion 408, above.

In operation, a drum 541 may be pre-loaded with rods of build material in some or all of guide channels 540. If a number of rods of build material 142 that is required to fabricate a desired component is fewer than a number of guide channels 540 in drum 541, fewer than all of the guide channels 540 may have rods of build material loaded therein. Protrusion 508 may interact with a rod of build material loaded in one of guide channels 540, causing the build material to be extruded by an extrusion head (not shown, but which may have any of the qualities of any of the extrusion heads described herein). In extruding the build material, protrusion 508 may move in the negative Z-direction (downward in the figures). After the rod of build material has been fully extruded, finger 508 move in the positive Z-direction until finger 508 reaches a location in which it is furthest from the extrusion head along the Z-axis. Drum 541 may rotate about its axis, indexing to the guide channel 540 having a rod of build material therein. The protrusion 508 may then engage with slot 542 of the guide channel 540 and move in the negative Z-direction to extrude the rod of build material disposed therein, repeating the process above.

FIG. 5 shows an exemplary system 600 for allowing loading, extrusion, and reloading of a rod of build material. System 600 may make use of any of the features of the other systems described herein. A body 606 may be movable in positive and negative Z-directions along a linear element 622 (e.g., a linear rail or a lead screw). A protrusion 608 may be pivotably coupled to body 606 via a spring 660.

Protrusion 608 may have a first, loading/reloading configuration and a second, extruding configuration. In the first configuration, shown in dotted lines in FIG. 5, protrusion 608 may be oriented so that protrusion 608 is oriented approximately parallel to an axis of rod of build material 142 and not intersecting an axis of rod of build material 162. In the first configuration, spring 660 may be lengthened compared to a relaxed, neutral length of the spring.

In a second configuration, as shown in solid lines in FIG. 5, protrusion 608 may be configured to contact and exert a force on a rod of build material 142. In the second configuration, the protrusion 608 may be oriented approximately perpendicular to an axis of rod of build material 142. To transition between the first and the second configurations, protrusion 608 may rotate about an axis A. In the first configuration, spring 660 may be at a relaxed, natural length.

In operation, when protrusion 608 moves in a negative z-direction and exerts a force on rod of build material 142 (using features from any of the other actuation systems described herein), protrusion 608 may be forced to pivot about axis A, causing mating surface 662 of protrusion 608 to contact a hard stop surface 664 of body 606. This may dramatically increase stiffness of protrusion 608. Spring 660 may also maintain contact between portions of protrusion 608 and body 606 when protrusion 608 is not in contact with rod of build material 142, which may remove or minimize backlash.

After one rod of build material 142 has been extruded, system 600 may be reloaded with another rod of build material 142. Body 606, and, as a result, protrusion 608, may be moved to a position furthest along the positive z-direction (e.g., the top of travel of body 606). Protrusion 608 may encounter a cam or may be actuated to move from the second configuration (solid lines) to the first configuration (dotted lines). Protrusion 608 may rotate (e.g., clockwise) about axis A during the transition.

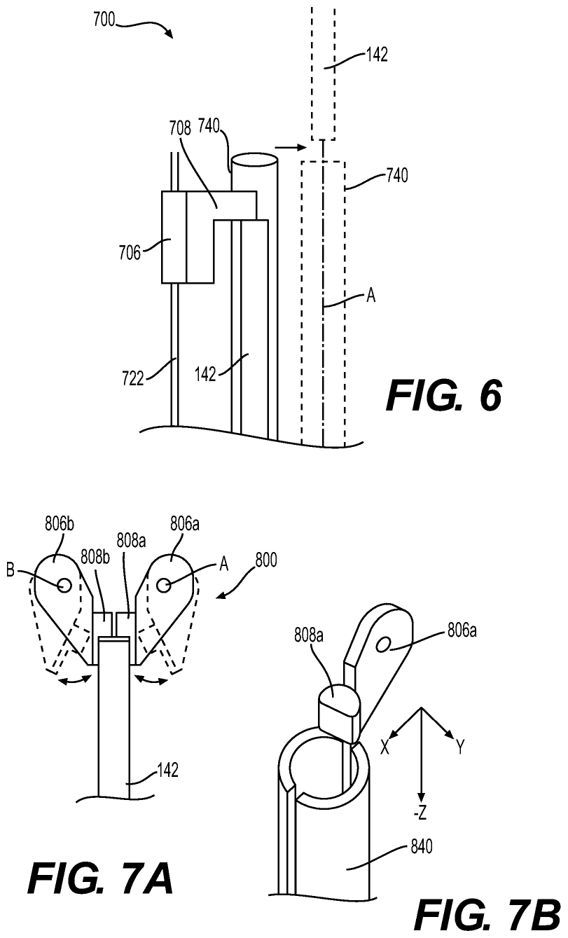

FIG. 6 shows another exemplary system 700 for allowing loading of a new rod of build material 142. System 700 may make use of any of the features of the systems above. System 700 may include at least one guide channel 740, which may have any of the properties of the guide channels described above.

A body 706 (having any of the properties of the bodies discussed above) may travel in the positive and negative Z-direction along a guide 722, which may be linear (e.g., a linear rail). A protrusion 708, having any of the features described above, may be fixed relative to body 706 (not rotate/translate relative to body 706). Protrusion 708 may contact and exert a force in the negative Z-direction on rod of build material 142.

After a rod of build material 142 is extruded, another rod of build material 142 may be loaded into guide channel 740. During reloading, guide channel 740 travels laterally or in another direction from an extrusion position (solid lines) to a reloading position (dotted lines), as shown in FIG. 6. A new rod of build material 142 (shown in dotted lines) may then enter the guide channel 740 along a reload axis A. The reloaded guide channel 740 then translates (or otherwise moves) from the reloading position (dotted lines) back to the extrusion position (solid lines) so the protrusion 708 can make contact with the rod of building material 142 in order to extrude the rod of building material 142.

FIGS. 7A and 7B show another exemplary system 800 for allowing extrusion and loading of a new rod of build material 142. System 800 may have any of the features of the systems described above. System 800 may include two rotatable bodies, 806a and 806b. Body 806a may rotate about an axis A, while body 806b may rotate about an axis B that is not coaxial with (e.g., approximately parallel to) axis A. In a first configuration (shown in solid lines in FIG. 7A, as well as in FIG. 7B), protrusions 808a and 808b of first and second bodies 806a, 806b, respectively, may contact a distal end and radially outward surfaces of a rod of building material 142 to help support, locate and center the rod of building material 142 as it is driven. The configuration shown in FIGS. 7A and 7B may be described as a closed configuration. Bodies 806a, 806b may pass through slots 842 of a guide channel 840. Slots 842 may extend longitudinally along a length of guide tube 840.

To extrude the rod of build material 142, bodies 806a, 806b may move in a negative Z-direction while bodies 806a, 806b are in the first configuration. To reload guide channel 840 with a new rod of build material 142, bodies 806a, 808b translate in an positive Z-direction to an end (e.g., the top end) of guide tube 840, where there is clearance for features (e.g., large radial features of bodies 806a, 806b) to exit slot 842 of guide tube 840 as the bodies 806a, 806b rotate about axes A and B, respectively, to a second configuration, shown in dashed lines in FIG. 7A. A cam, motor, or other component (such as any of those described with respect to other figures, herein) may be used to transition bodies 806a, 806b from the first configuration to the second configuration.

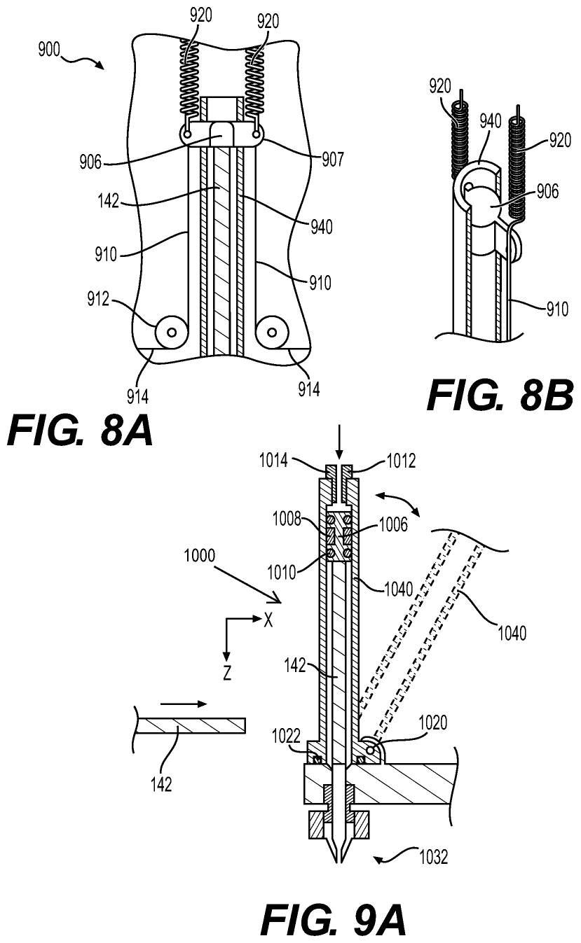

FIGS. 8A and 8B show another example system 900 for extruding a rod of build material 142. System 900 may use a ballista. System 900 may include a body 906 actuated via ballista cables 910 that pull body 906 toward extrusion head 132. Ballista cable(s) 910 may be reeled in via a winch 912 (which may be a rotary drum that reels in ballista cables 910, akin to a fishing line) and/or linear actuator.

Once the rod of build material 142 has been fully extruded, return springs 920 may provide tension in the ballista cables 910 to pull body 906 back to a position furthest in the positive Z-direction (e.g., the top) of travel, where a new rod of build material 142 can then be loaded. The winch 912 or linear actuator may be operable to actuate in the opposite direction from which it turns to pull body 906 toward extrusion head 132 in order for body 906 to move upwards. Body 906 and rod of build material 142 may both be constrained within a guide tube 940. Flanges 907 on the sides of the body 906 extend laterally through slots in guide tube 940 to provide attachment points for ballista cables 910 and/or springs 920. Reloading may occur with a new rod of my build material 142 entering the end of guide tube 940 that is furthest in a negative Z-direction, (e.g., the bottom of guide tube 940), because body 906 may not be able to move so as to allow reloading from a portion of guide tube 940 that is in the most positive Z-direction. Additionally or alternatively, guide tube 940 may split longitudinally for reloading a rod of build material 142 from a lateral direction.

FIG. 9A shows another example system 1000 for extruding a rod of build material 142. In system 1000, rod of building material 142 may be driven by pressure on a distal end (an end in a most positive Z-direction) of rod of building material 142 via a piston carriage 1006, which may be forced along the inside of a guide tube 1040 by pressure supplied by an external source (pressurized canister, pump, etc.). The solid lines show guide tube 1040 in an extrusion configuration, and the dashed lines show guide tube 1040 transitioning to a reload configuration, discussed in further detail below.

In system 1000, pressure may be supplied at an inlet 1014, formed by a nozzle 1012, and may be hydraulic, pneumatic, and/or any pressure arising from any other gas/liquid. Fluid pressure applied to piston carriage 1006 may isolated from a section of the guide tube 1040 in which rod of build material 142 resides via piston seal(s) 1010. Piston carriage 1006 may be aligned to an inner diameter of guide tube 1040 via a guide bushing 1008, which may minimize friction between the walls of guide tube 1040 and piston carriage 1006, as well as prevent misalignment.

Reloading of a new rod of build material 142 may occur once the previous rod is evacuated from guide tube 1040. To allow a new rod of build material 142 to enter guide tube 1040, guide tube 1040 may be rotated about a reload pivot 1020, following a trajectory denoted by the dashed outline on the right side of FIG. 9A. The guide tube reload pivot 1020 may be fixed to a frame, which holds extrusion head 1032 (which may have any of the properties of extrusion head 132). A new rod of build material 142 may then be reloaded into guide tube 1040, which is now aligned with the x-axis (horizontal in FIG. 9A, as shown by the arrow in FIG. 9A). Guide tube 1040 may then be rotated back to the position shown in solid lines in FIG. 9A, sealing a reload seal 1022 between guide tube 1040 and a frame of system 1000.

Although positive pressure is described herein, it will be appreciated that negative pressure (e.g., vacuum) may also be utilized in order to pull piston carriage 1006 in a negative z-direction.

FIG. 9B shows an exemplary actuation assembly 1050. An air source 1060 may provide air pressure in a direction shown by the arrow in FIG. 9B. Air source 1060 may receive air from any suitable source (e.g., a pressurized canister, a pump, or other source). Air pressure may drive rod of build material 142 along the z-axis by applying pressure to exposed surfaces of rod of build material that are within a sealed chamber 1054 formed by a housing 1052. The applied pressure may be directed in the directions toward rod of build material 142, shown by arrows in FIG. 9B. As a volume of chamber 1054 is filled by air, rod of build material 142 may be forced to exit along the negative z-direction.

A sealing interface 1062 (e.g., a seal such as an O-ring seal) may limit the amount of air which can escape from chamber 1054. Sealing interface 1062 may conform (e.g., may be compliant) to an outer surface of rod of build material 142 in order to minimize air which can escape from chamber 1054. Increasing a seal of chamber 1054 may increase an amount of pressure which may be applied to rod of build material 142 in order to overcome a force required to extrude rod of build material 142 and associated mechanism friction. Alternatively, both sealing interface 1062 and outside surface of rod of build material 142 may be very tightly controlled to achieve a gap between them of less than approximately 20 um.

To reload assembly 1050, chamber 1054 may be de-pressurized to ambient conditions and then opened to allow a new rod of build material 142 to enter chamber 1054. External surfaces of a previous or current rod of build material 142 may be in contact with sealing interface 1062 to enable further actuation. To reload, a top (a portion furthest in the positive z-direction) of chamber 1054 may open (e.g., laterally, via a rotating lid, or by another mechanism) and a new rod of build material 142 may enter through the top of chamber 1054 (e.g., via a pick and place mechanism, gravity, or another mechanism). The top of chamber 1054 may then close to re-establish a pressure seal and actuate rod of build material 142. Alternatively, a bottom of chamber 1054 (a portion furthest in the negative z-direction) may open (e.g., laterally, via rotation, etc.), and a new rod of build material 142 may enter the bottom of chamber 1054. The chamber bottom may then close to re-establish the pressure seal prior to further extrusion. In another alternative, chamber 1054 may split open (e.g., like a clam shell), and a new rod of build material may enter chamber 1054 laterally. Chamber 1054 may close once the new rod of build material 142 has been loaded. Alternatively, a telescoping chamber 1054 may be utilized, which may retract in order to load a new rod of build material 142.

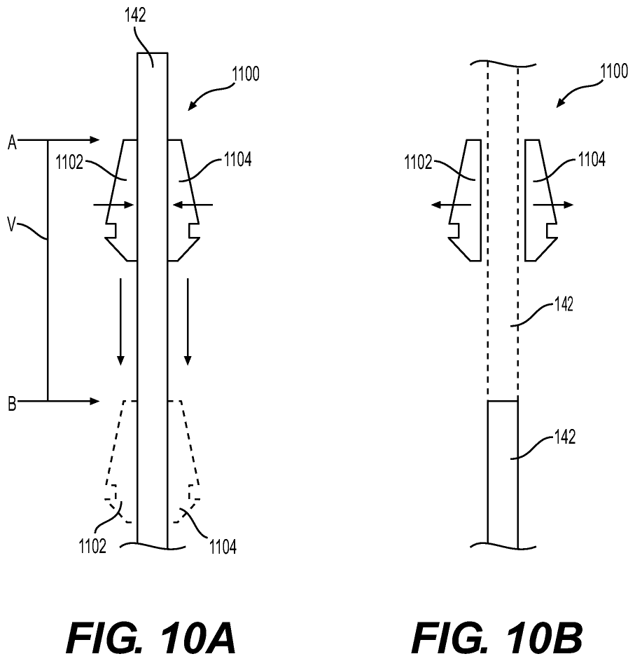

FIGS. 10A-18B depict aspects of example systems that grip rods of build material 142 and pull them toward extrusion head 132. A radially/laterally inward pressure may be applied to an external surface of rod of build material 142 by a gripping element. The gripping elements may conform to the outer surface of rod of build material 142, or have serrations which indent into rod of build material 142 to provide additional resistance to slippage. The gripping elements may generate at least two opposing lateral forces. Once the gripping forces are applied, the gripping element(s) may force the rod of build material 142 to be moved along the Z axis via a shear force. Additionally or alternatively, indentations or mating features in rod of build material 142 may cause forces on rod of build material 142 as with the pushing examples, above. The gripping element(s) may actuate rod of build material 142 for at least approximately 1mm to at least approximately 150 mm before releasing rod of build material 142 and resetting to a position at a start of travel. A total travel of the gripping element(s) may define an actuating volume. In the gripping mechanisms described herein, support for rod of build material 142 can be provided by the gripping element(s) themselves. Guiding elements may be used to support portions of the rod which are not in the actuating volume.

FIGS. 10A and 10B depict aspects of travel of a gripping element 1100. Various types of gripping elements will be discussed below, and any of those gripping elements may have the travel pattern shown in FIGS. 10A and 10B. The configuration shown in FIGS. 10A and 10B is merely exemplary and is for illustration purposes only. As shown in FIGS. 10A and 10B, gripping element 1100 may have a first gripping surface 1102 and a second gripping surface 1104 configured to exert lateral/radially inward forces on rod of build material 142. After gripping and extruding a first rod of build material 142, a subsequent rod of build material 142 may be gripped once at least a portion of an actuating volume V is free. Actuating volume V may be defined by a total travel of a gripper mechanism 1100. For example, as shown in FIG. 10A, actuating volume V may be defined by subtracting position B (an ending position of gripper mechanism 1100) from position A (a starting position of gripper mechanism 1100). Although actuating volume V is described specifically with respect to FIGS. 10A and 10B, it will be appreciated that each of the assemblies described herein includes an actuation volume over which rod 142 may be actuated.

Reloading of a new rod of build material 142 may occur by opening gripper mechanism 1100 to a state which is larger than the maximum cross-sectional area of rod of build material 142. A portion of a new rod of build material 142 may then enter the actuation volume (e.g., by being dropped from the positive Z-direction (e.g., a top), entering laterally, a combination). The dotted outline of FIG. 10B is a region for new rod of build material 142 to drop in. Gripper mechanism 1100 may then close onto new rod of build material 142 and continue to actuate the new rod of build material 142 along the Z axis.

Gripping element 1100 may be forced into contact with sides of rod of build material 142 via an actuator (not shown in FIGS. 10A and 10B). Example actuators are described below and may include, for example, pneumatic cylinders, solenoids, air bladders, mechanical cams, flexural collets, or other mechanisms. Gripping element 1100 may be connected to a gripper carriage (not shown in FIGS. 10A and 10B), which can actuate along the Z-axis from point A to point B. Actuation of the gripper carriage may be accomplished by any actuation assembly described above with regard to FIGS. 2A-9B.

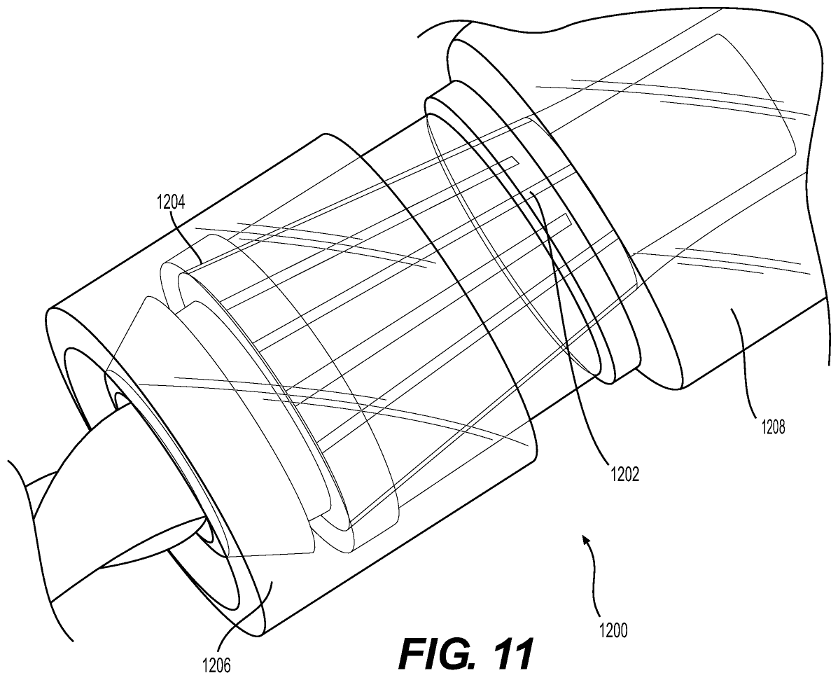

In one example, gripping element 1100 may include a collet 1200, as shown in FIG. 11. Vertical slits 1202 in collet 1200 may allow an inner diameter of collet 1200 to expand and contract. As a ramp 1204 (e.g., a shallow ramp) on collet 1200 contacts a tool holder 12086, an inner diameter of collet 1200 may contract. Collet 1200 may be actuated axially via a nut 1206, which may pull collet 1200 into tool holder 12081208. In the contracted configuration of collet 1200, collet 1200 may grip and hold rod of build material 142 (not shown in FIG. 11). To release rod of build material 142, collet 1200 may be transitioned to an expanded configuration, in which tool holder 1208120 does not constrain collet 1200. Nut 1206 may axially actuate collet 1200 to move collet 1200 relative to tool holder 1208120 and to disengage collet 1200 from tool holder 1208120 so as to release rod of build material 142.

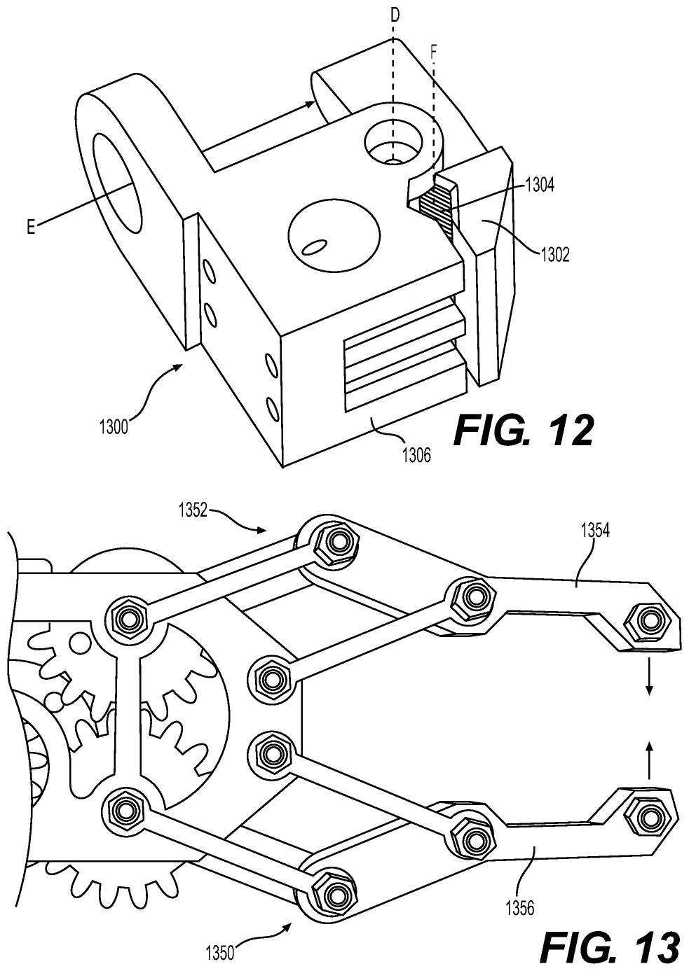

FIG. 12 shows an example gripping element 1300, features of which may be used in combination with other examples provided herein. As shown in FIG. 12, gripping element 1300 may include a gripper arm 1302 that is pivotable about an axis D. An actuator (not shown) may be used to pivot gripper arm 1302 and may include, for example, a solenoid, a pneumatic cylinder, a motor, an air bladder, or other type of actuator. The actuator may act on gripper arm 1302 along axis E, so that gripper arm 1302 moves like a lever.

A gripper carriage 1306 may carry gripping element 1300. Gripper carriage 1306 may move in order to actuate rod of build material 142 along an axis F of rod of build material 142 (not shown in FIG. 12). For example, gripper carriage 1306 may be movable along an axis parallel to an axis F of rod of build material 142.

Rod of build material 142 may be received by gripper arm 1302 (e.g., between gripper arm 1302 and gripper carriage 1306) along an axis F. Pivoting of gripper arm 1302 may create a lever action that generates pressure on the outer surface of rod of build material 142. Serrations 1304 on an inner surface of gripper arm 1302 may indent into an outer surface of rod of build material 142 or interact with surface features of rod of build material 142 (e.g., corresponding protrusions).

In alternatives, gripper arms may function by mechanisms alternative to the pivot axis described with respect to FIG. 12. For example, as shown in FIG. 13, a gripping element 1350 may include linkages 1352 to facilitate translation of arms 1354 and 1356 of gripping element 1350. Translation of arms 1354 and 1356 may be linear along the arrows shown in FIG. 13, rather than rotational as with gripping element 1300. A linkage of gripping element 1350 may include gears, arms, or other structures to facilitate opening and closing of arms 1354, 1356 to grip and/or release rod of build material 142.

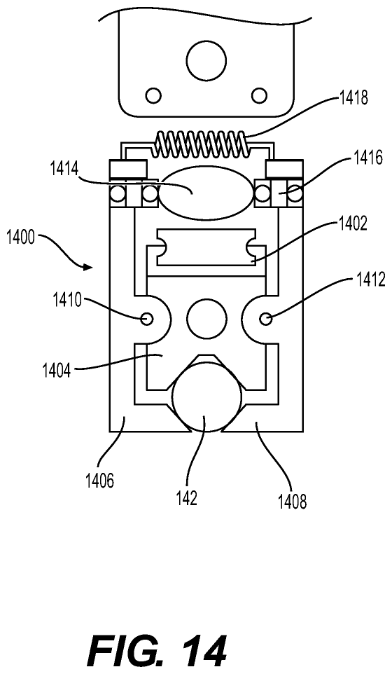

FIG. 14 depicts an example gripping element 1400. A linear guide 1402 may extend in and out of the page (along a distance of approximately 150 mm, for example). A gripper carriage 1404 (e.g., having a length, width, or height of approximately 40 mm) may travel along linear guide 1402. Rod of build material 142 may fit between two gripper arms 1406, 1408 and gripper carriage 1404.

Gripper arms 1406, 1408 may open and close about pivot points 1410, 1412, respectively. Gripper arms 1406 may be configured to be opened and closed by rotation of a cam 1414. Cam 1414 may have an oval or ovoid shape. Cam 1414 may be formed via, e.g., extrusion. Rotation of cam 1414 by 90 degrees may cause gripper arms to close 1406, 1408 to close and contact rod of build material 142 and to open to release rod of build material 142 and reload another rod of build material 142.

FIG. 14 depicts arms 1406, 1408 in a closed configuration, in which a long axis of cam 1414 is in contact with cam rollers 1416, which may be coupled to arms 1406, 1408. In the closed configuration, arms 1406 and 1408 may contact rod of build material 142 so that they can exert a radially inward force on rod of build material 142 and move rod of build material 142 toward extrusion head 132.

To open arms 1406, 1408, cam 1414 may be rotated 90 degrees, so that a short axis of cam 1414 extends between cam rollers 1416. A spring 1418 may extend between cam rollers 1416 and may be biased into the open configuration. Therefore, when cam 1414 is rotated, spring 1418 may pull cam rollers 1416 together, causing arms 1406 and 1408 to rotate about pivot points 1410 and 1412, respectively. This pivoting may cause arms 1406 and 1408 to open (ends of arms 1406 and 1408 opposite cam rollers 1416 may become farther apart from one another). In the open configuration, arms 1406 and 1408 may not contact a rod of build material 142. The open configuration may be used for reloading.

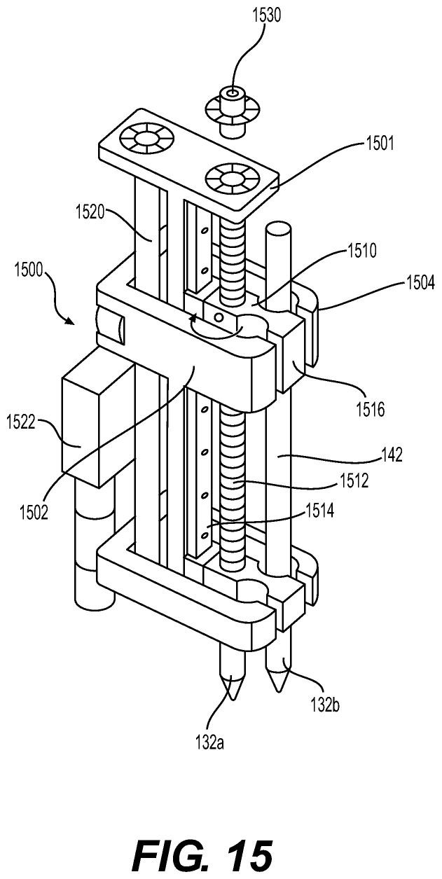

FIG. 15 shows an extrusion assembly 1500 that may have any of the properties of element 1400. Assembly 1500 may allow actuation of two or more rods of build material 142 concurrently, via a single mechanism. Assembly 1500 may include a frame 1501 housing arms 1502, 1504 that can independently open to independently grip or release rods of build material 142. In order to show the features of extrusion assembly 1500, only one rod of build material 142 is shown. Additionally or alternatively, arms 1502, 1504 may jointly move to open and close about rods of build material 142 simultaneously.

Extrusion assembly 1500 may include a plurality of extrusion heads, such as extrusion heads 132a, 132b. Rods of build material 142 may be actuated toward extrusion heads 132a, 132b. A carriage 1510 may be movable along a Z-axis toward and away from extrusion heads 132a, 132b. The carriage may be driven by a linear element 1512 (e.g., a lead screw). Carriage 1510 may be movable along a linear guide 1514 (e.g., a linear rail).

Carriage 1510 may include arms 1502, 1504. Each of arms 1502, 1504 may be pivotable about pivot points. Rods of build material 142 may be received between a one of arms 1502, 1504, and central portion 1516 of carriage 1510 that is between arms 1502, 1504. Central portion 1516 may be formed (e.g., molded) so that surfaces of central portion 1516 mate with surfaces of rods of build material 142. Arms 1502, 1504 may be movable relative an x- or y-direction relative to central portion 1516, while central portion 1516 may be movable in a z-direction but not in an x- or y-direction.

A cam 1520 may extend along the z-axis, along an entirety of a path of travel of carriage 1510. Cam 1520 may have an ovular cross-section, like the cam described above with respect to FIG. 14. Cam 1520 may be rotated so that either a short axis or a long axis of cam 1520 engages with arm 1502, causing arm 1502 to pivot open and closed. Optionally, cam 1520 may be positioned so that it contacts both arm 1502, 1504, causing both of arms 1502, 1504, as with gripping element 1400. Alternatively, a second cam (not shown) may be positioned so that it contacts arm 1504, causing it to open and close separately from arm 1502. Cam 1520 may be actuated via a motor 1522 or via a mechanical switch, such as a basher bar.

An encoder 1530 may be used in order to provide instructions regarding when cam 1520 (or any other cam) should rotate to cause arms 1502 and/or 1504 to open and/or close. Arms 1502 and/or 1504 may open and/or close at various points along a path of travel of carriage 1510 along the Z-axis. Different encoders 1530 may be used for different desired patterns of opening and closing of arms 1502 and/or 1504.

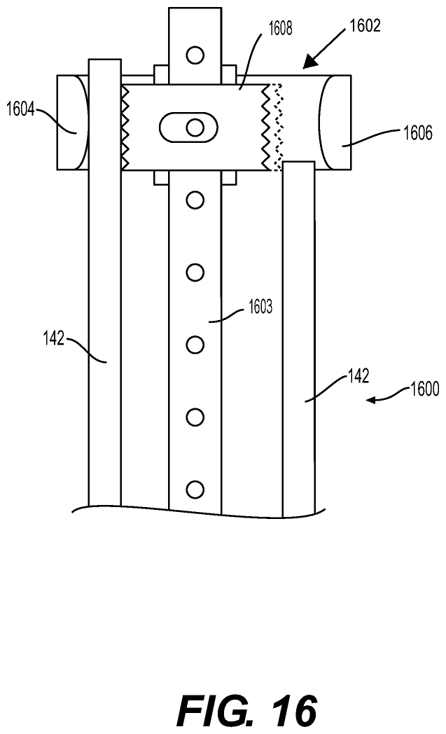

FIG. 16 shows an actuation assembly 1600. As with the actuator of extrusion assembly 1500, actuation assembly 1600 may concurrently move two (or more) rods of build material 142 along the Z-axis. A carriage 1602 may move along the Z-axis, along a linear element 1603 (e.g., a lead screw or other element). Gripper carriage 1602 may include two fixed arms 1604, 1606. A gripper 1608 may be disposed between arms 1604. Gripper 1608 may be configured to translate perpendicularly to the Z-axis (along the X-axis and/or Y-axis).

In a first position of gripper 1608 (shown in FIG. 16), gripper 1608 may contact a first rod of build material 142 to sandwich rod of build material 142 between gripper 1608 and arm 1604. In the first position, rod of build material 142 adjacent to arm 1604 may be gripped in order to actuate rod of build material 142 along the Z-axis. Gripper 1608 may be translated to a second position (may move to the right in FIG. 16) to sandwich rod of build material 142 between gripper 1608 and arm 1606. In the second configuration, rod of build material 142 adjacent to arm 1606 may be actuated along the Z-axis. Gripper 1608 may be translated at different points of travel of carriage 1602 along the Z-axis in order to grip or release rods at different points.

The mechanisms described with respect to FIGS. 15 and 16 allow multiple rods to be actuated with a single mechanism, which may reduce overall moving mass. Alternative mechanisms may also be used to concurrently advance multiple rods and to change a grip between the multiple rods.

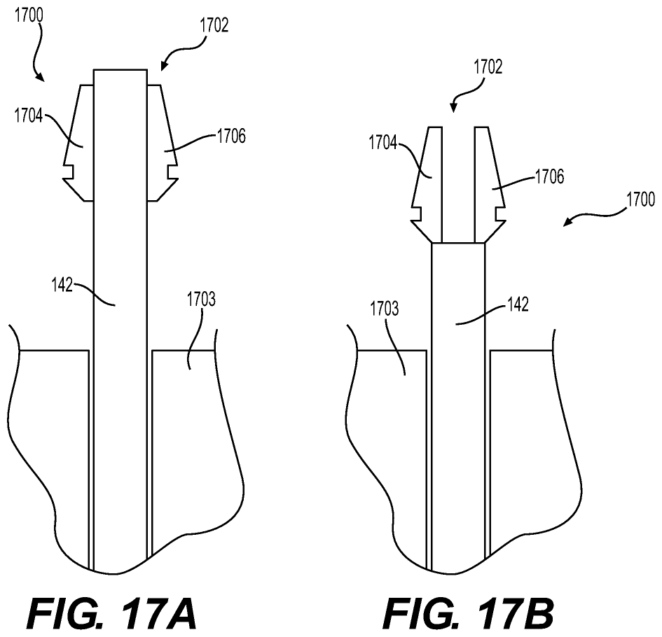

FIGS. 17A and 17B depict another example actuation assembly 1700. Actuation assembly 1700 may include a gripper 1702 housed in a frame 1703. Gripper 1702 may operate like any of the mechanisms above to open and close in order to exert a lateral/radially inward force on rod of build material 142. For example, as shown in FIG. 17A, gripper 1702 may have arms 1704, 1706 that may open and close about rod of build material 142 to exert a lateral force on rod of build material 142 or to release rod of build material 142.

As shown in FIG. 17B, actuation assembly 1700 may also be configured to transition to a pushing configuration, in which arms 1704, 1706 are closer together than in a gripping or a released configuration. A distance between arms 1704, 1706 may be less than a thickness (diameter) of rod of build material 142. To actuate rod of build material 142, gripper 1702 may be closed so that arms 1704, 1706 contact and exert a force on rod of build material 142. Gripper 1702 may be actuated in the negative Z-direction in order to advance rod of build material 142 toward extrusion head 132. After rod of build material 142 has been advanced a particular amount (e.g., an entire range of motion along which gripper 1702 may grip rod of build material 142), gripper 1702 may be opened to release rod of build material, moved along the positive Z-direction, and then transitioned to the configuration of FIG. 17B. Gripper 1702 may then be actuated in the negative Z-direction in order to push rod of build material with a surface of gripper 1702 that faces the negative Z-direction. This pushing by gripper 1702 may increase an actuating volume for a given size of actuating assembly 1700, and may decrease a mass or dimension (e.g., length or width) of actuating assembly 1700. Pushing by gripper 1702 in the configuration of FIG. 17B may obviate a need to complete extrusion of a first rod of build material 142 by pushing the first rod of build material 142 with a subsequent rod of build material 142.

In addition to or alternatively to the mechanisms described above, gripping elements described herein may also exert forces on rods of building material 142 via other mechanisms. For example, vacuum or suction may be utilized, particularly where rod of build material 142 is not round (e.g., where rod of build material 142 has flat sides). Additionally or alternatively, current may be applied to rod of build material 142 via, e.g., a wire (e.g., a nitinol wire) wrapped around rod of build material 142. Additionally or alternatively, a collapsible ring may be disposed about rod of build material 142. For example, a hollow structure (e.g., a donut) may surround rod of build material 142. When air pressure is applied to the hollow structure, the hollow structure may contract about rod of build material 142 (e.g., when the donut is inflated). Negative pressure may be applied to release rod of build material 142.

In the examples described above, lateral (radially inward forces) on rod of build material 142 may serve to grip and move rod of build material 142. Alternatively or additionally, a gripping element and/or rod of build material 142 may include features so that the gripping element may exert a force along a longitudinal axis of rod of build material 142. The aspects described below may be used with any of the examples having a gripping element, described above.

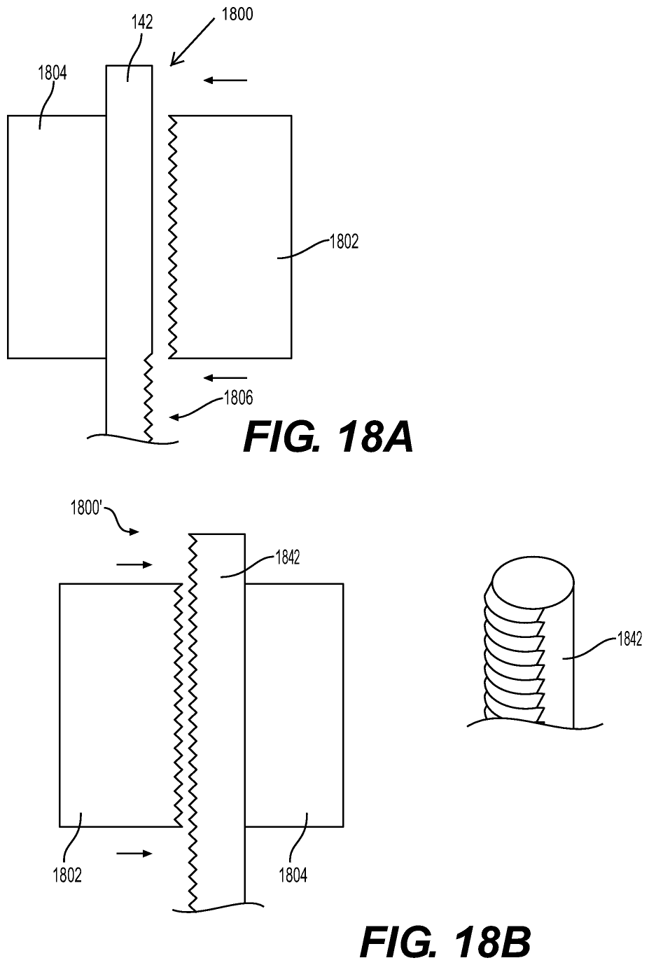

For example, as shown in FIG. 18A, actuation assembly 1800 may include a toothed gripping element 1802 that may act on a smooth rod of build material 142. Teeth or protrusions of gripping element 1802 may bite into a radially outward surface of rod of build material 142, causing corresponding indentations on portions of rod of build material 142 that have already engaged with gripping element 1802. As the teeth of gripping element 1802 bite into rod of build material 142, the teeth may exert a force on rod of build material 142 along a longitudinal axis of rod of build material 142. When gripping element 1802 bites into rod of build material 142, rod of build material 142 may be cold (e.g., ambient temperature) or may be preheated to ease engagement. If rod of build material 142 is heated, gripping element 1402 may locally melt and/or deform a surface of gripping element 1802. As shown in FIG. 18A a portion 1806 of rod of build material 142 that has already passed toothed gripping element 1802 (is downstream of gripping element 1802) may have grooves resulting from the teeth of toothed gripping element 1802.

Alternatively, as shown in FIG. 18B, actuation assembly 1800′ may have a toothed gripping element 1802 that may act on a molded rod of build material 1842. FIG. 18B shows rod of build material 1842 in actuation assembly 1800′, as well as an enlarged perspective view of rod of build material 1842. Rod of build material 1842 may be molded or otherwise formed such that a shape of an outer surface of rod of build material 1842 is complementary to (mating with) teeth of griping element 1802. For example, rod of build material 1842 may include teeth. Rod of build material 1842 may be injection molded, extruded, deformed by heated forming tools, or otherwise be formed to have features to mate with toothed gripping element 1802. The features may be formed prior to rod of build material 1842 engaging with gripping element 1802. Having the features be pre-formed may reduce a risk of local failure (e.g., stripping), because rod of build material 1842 may not have been plastically deformed.

FIGS. 18A and 18B show a restraint 1804 on an opposite side of rod of build material 142, 1842 from gripping element 1802. Restraint 1804 may serve as a guide for rod of build material 142, 1842 and may keep rod of build material 142, 1842 appropriately aligned. Alternatively, restraint 1804 may be replaced with a second gripping element, which may have any of the properties of gripping element 1802. Any gripping elements (including gripping element 1802) may be actuated so as to come into contact with and/or release rod of build material 142 or 1842. Arrows in FIGS. 18A and 18B show a direction of movement of gripping element 1802.

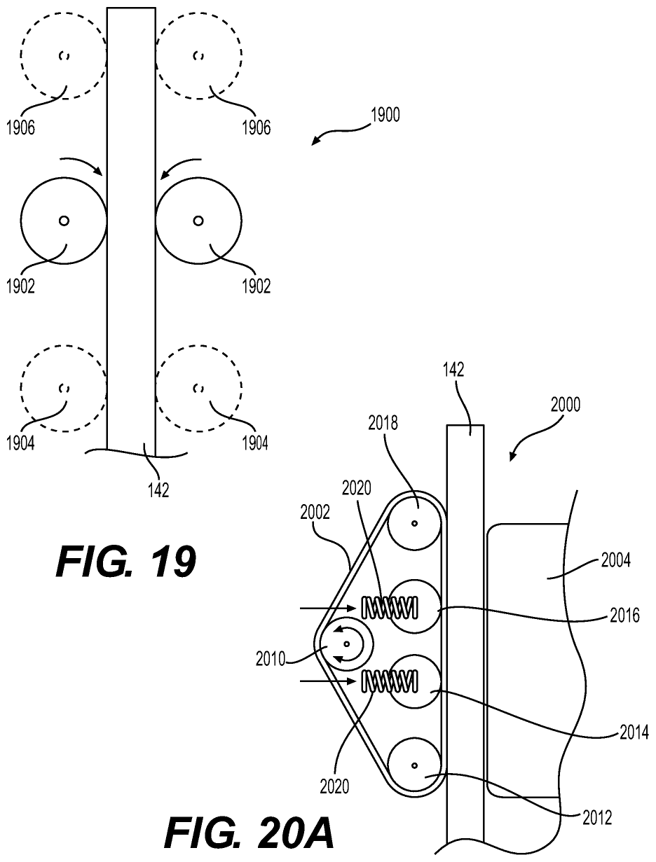

FIGS. 19-22 depict exemplary mechanisms for providing continuous (or approximately continuous) lateral pressure on rod of build material 142. As shown below, the mechanisms may include rollers that apply continuous and/or constant pressure to rod of build material 142.

FIG. 19 depicts an actuation assembly 1900 having a pair of rollers 1902 that can rotate in the direction shown by the arrows in FIG. 19. Rod of build material 142 may be received between rollers 1902 so that rollers 1902 exert radially (i.e., laterally) inward forces on rod of build material 142. Rollers 1902 may be smooth or may have features (e.g., protrusions or indentations) to mate with corresponding features on rod of build material 142. For example, rollers 1902 may function similar to pinions, and rod of build material 142 may function similarly to a rack. Mating features on rollers 1902 and rod of build material 142 may be pre-formed to be complementary, or rollers 1902 may bite into rod of build material 142 to form the complementary features.

Rollers 1902 may be preloaded and/or biased toward one another. One or more of rollers 1902 may be preloaded/biased toward the other or both rollers 1902 may be preloaded/biased toward one another. For example, rollers 1902 may be biased via, e.g., a spring loaded pivot arm, pneumatic cylinder, magnetic assembly, or other mechanism. A biasing/preloading mechanism may allow a distance between rollers 1902 to vary. Variances in the distance between rollers 1902 may account for variations in diameter of rod of build material 142, while maintaining a consistent or approximately consistent lateral force on rod of build material 142. Alternatively, a distance between rollers 1902 may be constant, and diameters of rods of build material 142 may be tightly controlled. Alternatively, rollers 1902 may be compliant to accommodate varying widths of rod of build material 142. Alternatively, rollers 1902 may be made from material that is rigid so as to promote indentation/deformation of features of rollers into the rod, or soft to conform to the outer surface of the rod to more evenly distribute lateral pressure.

Dimensions of actuation assembly 1900, including size of rollers 1902 may be chosen to apply the desired forces. Increasing area over which lateral pressure is distributed may increase the maximum shear/lateral force (driving force), which may reduce the risk of slippage and/or material failure (stripping) of rod of build material 142. Increasing roller 1902 diameter also increases pressure distribution area. Control over lateral forces exerted on rod of build material 142 (e.g., via springs or other structures, as described above), a force of extrusion of rod of build material 142 may be chosen to prevent or minimize damage of rod of build material 142 and/or over-pressurized states. For example, roller 1902 may function as a variable slip clutch.

Any of the linear alignment mechanisms (e.g., tubes, rails, rollers, etc.) described above may be used to maintain rods of build material 142 along the z-axis as they are driven by roller 1902. Alignment mechanisms may also maintain orientation of a multiple rods of build material 142 as an interface between rods of build material 142 passes through actuation assembly 1900.

Although a pair of rollers 1902 are described above, as shown in dotted lines in FIG. 19, actuation assembly 1900 may also include one or more additional pairs of rollers, such as pairs of rollers 1904, 1906. Any suitable numbers of rollers may be used and the three sets of rollers 1902, 1904 1906 shown in FIG. 19 are merely exemplary. Utilizing a plurality of pairs of rollers may increase a maximum force that can be applied to extrude rod of build material 142 before slippage occurs between a surface of rod of build material 142 and the rollers.

Alignment mechanisms(s) may be disposed between pairs of rollers 1902, 1904, 1906 to maintain an orientation of rods of build material 142 as an interface between successive rods of build material 142 passes through pairs of rollers 1902, 1904, 1906. Alternatively, where a space between successive rods of build material 142 is small enough (and a contact area between pair of rollers 1902) is large enough, a single pair of rollers 1902 may adequately pass successive rods of build material 142 because pair of rollers 1902 may simultaneously grip two successive rods of build material 142. Alternatively, multiple pairs of rollers (e.g., 1902, 1904, 1906) may be used so that a force (e.g., a preload force) is continuously present on at least one rod of build material 142. An upstream-most pair of rollers (the pair of rollers furthest in the positive z-direction) may radially open to widen a passage way for rod of build material 142 while a new rod of build material 142 enters the actuation volume. The upstream-most pair of rollers may then close and actuate synchronously with the other rollers.

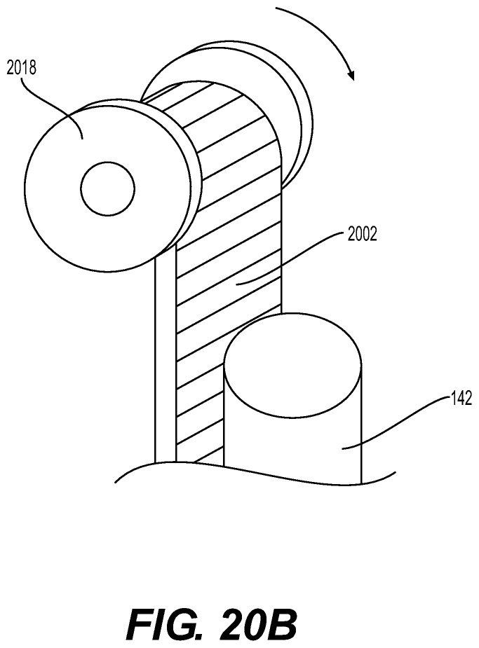

FIGS. 20A and 20B depict an exemplary actuation assembly 2000. Actuation assembly 2000 utilizes a belt 2002 to actuate rod of build material 142. Belt 2002 may provide a greater contact area with rod of build material than discrete rollers. Rod of build material 142 may be received between belt 2002 and a restraint 2004.

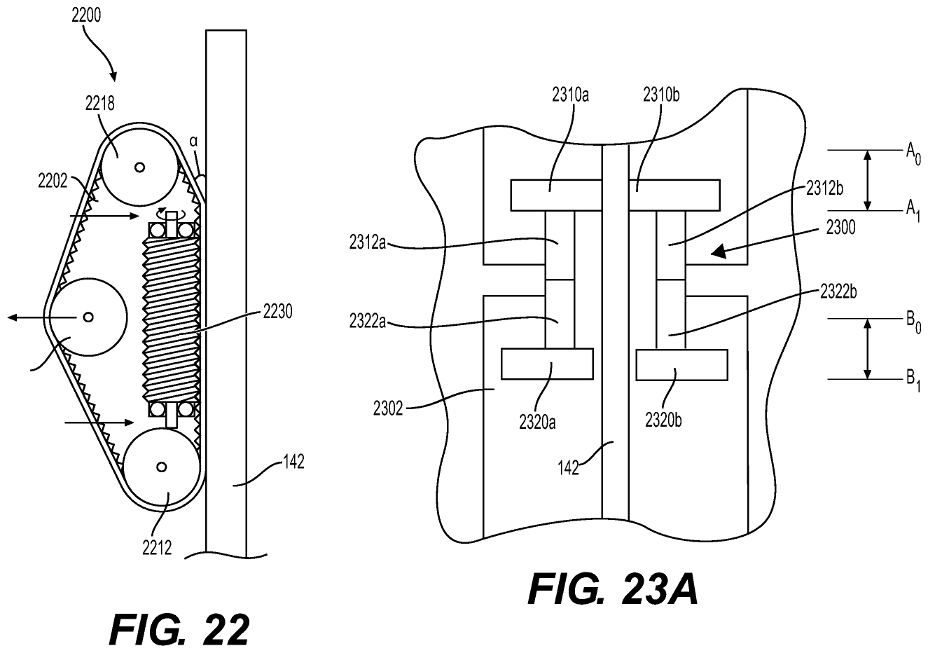

A pulley 2010 may be driven by a motor (not shown) to translate belt 2002 around its path. Belt 2002 may be tensioned to remove slack, as avoiding slack may improve linear accuracy. For example, as shown in FIG. 20A, rollers 2014, 2016 may be preloaded via springs 2020. Rollers 2014, 2016 may exert a force on belt 2002 shown by the arrows in FIG. 20A. The force from rollers 2014, 2016 may push belt 2002 against rod of build material 142. Rollers 2012, 2014 may define a longitudinal extent of belt 2002. For example, roller 2018 may define an upstream-most portion of belt 2002. Roller 2018 may be parallel with rollers 2012, 2014, 2016, as shown. Alternatively, roller 2018 (an upstream-most roller) may be laterally offset from rollers 2012, 2014, 2016. For example, roller 2018 may be arranged as roller 2218, described below with respect to FIG. 22. Offset roller 2018 may form a lead-in for receiving a new rod of build material 142.

Restraint 2004 may provide a reaction force/opposing force to the applied to rod of build material 142 via rollers 2014, 2016. Restraint 2004 may also provide alignment, maintaining rod 142 along the z-axis during actuation. Restraint 2004 may include, for example, a fixed feature (e.g., low-friction PTFE block, passive rollers, or other structures) or a feature that actively preloads rod of build material 142 against rollers 2014, 2016 or a mirrored actuator assembly. If the actuator is mirrored, the actuators (e.g., rollers) may be driven from the same motor.

As shown in FIG. 20B, belt 2002 may include protrusions, like those described above with respect to other figures. The protrusions may mate with features on rod of build material 142 (not shown in FIG. 20B) or may bite into rod of build material 142 to create indentations on rod of build material 142, in order to reduce a likelihood of slipping and/or stripping of rod of build material 142. Belt 2002 may be rigid or may be compliant so as to conform to a surface of rod of build material 142.

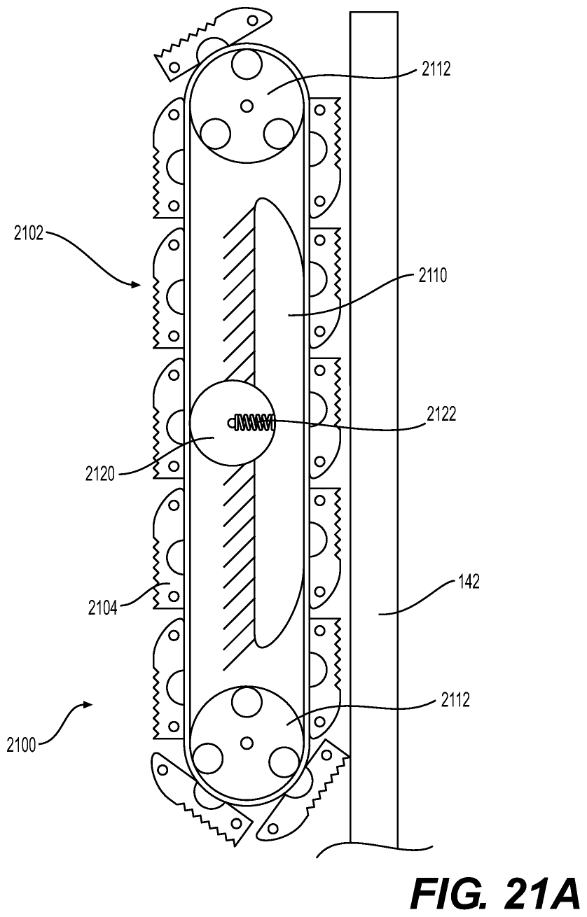

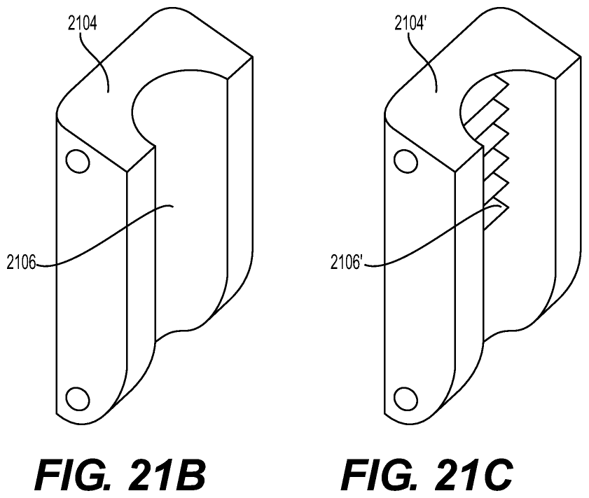

FIG. 21A shows an actuation assembly 2100 that may have any of the properties of actuation assembly 2000. Instead of belt 2002, actuation assembly 2100 may include a tread 2102 (e.g., a tank tread), which may include discrete segments 2104. Discrete segments 2104 may be coupled to one another and may pass around two rollers 2112, defining ends of tread 2102 in a positive-most and negative-most z-direction. One or more of rollers 2112 may be driven pulleys powered by a motor (not shown).

A fixed support 2110 may exert a lateral force on tread 2102 toward rod of build material 142. Fixed support 2110 may be encircled by tread 2102. Fixed support 2110 may define a side of tread 2102 between rollers 2112. A preloaded roller 2120 may exert a force on a portion of tread 2102 opposite rod of build material 142 in a direction away from rod of build material 142. Roller 2120 may assist in maintaining tension on tread 2102. Roller 2120 may be preloaded via a spring 2122 extending between fixed support 2110 and roller 2120.

FIGS. 21B and 21C depict exemplary segments 2104 and 2104′. Segments 2104 and 2104′ may have any of the properties of belt 2002. As shown in FIG. 21B, a surface 2106 of segment 2104 facing rod of build material 142 may be smooth. Alternatively, as shown in FIG. 21C, a surface 2106′ of segment 2104′ facing rod of build material 142 may have ridges or projections, as described with respect to FIG. 20B, above.

FIG. 22 shows an exemplary actuation assembly 2200. Actuation assembly 2200 may include a belt 2202, which may have any of the properties of belt 2002, and may have protrusions or teeth. Rollers 2212 and 2218 may have any of the properties of rollers 2012 and 2018, respectively.

A worm gear 2230 may be rotatable about a longitudinal axis thereof. Worm gear 2230 may be operative to actuate belt 2202. Mating features (e.g., teeth or projections) on a surface of belt 2202 facing worm gear 2230 (opposite rod of build material 142) may engage with corresponding mating features on worm gear 2230. For example, belt 2202 may have properties of a timing belt. Worm gear 2230 may enforce a preload pressure on rod of build material 142 over a greater surface area than other types of belts or tread assemblies. Worm gear 2230 may be laterally and longitudinally fixed (relative to a frame or restraint (e.g., restraint 2004) or float laterally with a preload mechanism.

An arrangement of roller 2218 may produce a lead-in angle a is used to promote alignment of successive rods of build material 142 as they are loaded into the extruder. Lead-in angle α may provide a funneling effect on rod of build material 142.

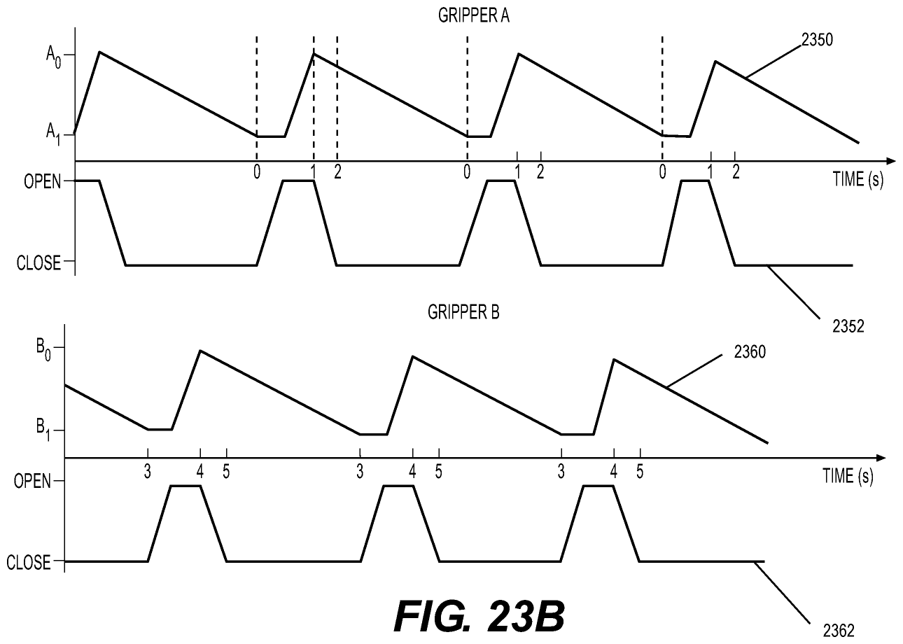

FIG. 23A depicts an exemplary actuation assembly 2300. Components of actuation assembly 2300 may be housed in a housing 2302. Actuation assembly 2300 may include a first pair of gripping arms 2310a, 2310b, and a second pair of gripping arms 2320a, 2320b. First pair of gripping arms 2310a, 2310b may actuate along or be actuated by linear actuators 2312a, 2312b, respectively. Second pair of gripping arms 2320a, 2320b may actuate along or be actuated by linear actuators 2322a, 2322b, respectively.

Gripper arms 2310a, 2310b, 2320a, 2320b may apply lateral pressure to rod of build material 142 (via, for example mechanical CAMs, air pressure, additional linear actuators, or any other suitable structure). By timing gripping, releasing and linear actuation of the gripper arms 2310a, 2310b, 2320a, 2320b, continuous motion of rod of build material 142 occurs. Gripper arms 2310a, 2310b, 2320a, 2320b may function like an inchworm, walking along rod of build material 142.

Actuation of rod of build material 142 may occur only when at least one of the pairs of grippers 2310a, 2310b or 2320a, 2320b is in contact with rod of build material 142. Once in contact with rod of build material 142, at least one of the pairs of gripper arms 2310a, 2310b or 2320a, 2320b may travel a small distance (e.g., ≥100 um).

Linear actuators 2312a, 2312b, 2322a, 2322b may generate relatively small displacement relative to frame 2302. For example, linear actuator 2312b can move point A on gripper arm 2310b from location A0 to location A1. Location A0 may be at the top of travel (furthest in a positive z-direction), and location A1 may be at the bottom of travel (furthest in a negative z-direction). Linear actuator 2322b can move point B on gripper arm 2320b from location B0 to location B1. Location B0 may be at the top of travel (furthest in a positive z-direction), and location B1 may be at the bottom of travel (furthest in a negative z-direction). In FIG. 23A, gripper arm 2320b is shown to be in contact with rod of build material 142, whereas gripper 2310b is in the open state not in contact with rod of build material 142. Gripper arms 2310a, 2320a may move in conjunction with gripper arms 2310b, 2320b, respectively.

Actuation of either of pair of gripper arms 2310a, 2310b or 2320a, 2320b may include three main events, which may be repeated successively. In a first, resetting step pair of gripper arms 2310a, 2310b or 2320a, 2320 may be opened and moved to the top of travel. In a second, closing step, pair of gripper arms 2310a, 2310b or 2320a, 2320b may be closed onto rod of build material 142. In a third, actuating step, pair of gripper arms 2310a, 2310b or 2320a, 2320b may be moved to the bottom of travel. At all times, at least one of pairs of gripper arms 2310a, 2310b or 2320a, 2320b may be engaged with the rod while the other is resetting to its maximum travel.

Timing of each of the grippers may be calibrated to minimize the overlap of the resetting steps for both grippers. An example timing of resetting, gripping and actuating of each gripper is illustrated in the timing chart shown in FIG. 23B. This table is a specific implementation which generates continuous motion of the rod. Other timings and/or patterns may be utilized. Gripper A in FIG. 23B may correspond to pair of gripper arms 2310a, 2310b. Gripper B in FIG. 23B may correspond to pair of gripper arms 2320a, 2320b.

Subplot 2350 corresponds to a position of gripper A within its travel from A0 to A1. Subplot 2352 corresponds to a state of the gripper A—open or closed on rod of build material 142. On the x-axis (time) there are 3 key times marked on the axis (times 0, 1, and 2). Subplot 2360 corresponds to a position of gripper B within its travel from B0 to B1. Subplot 2362 corresponds to a state of the gripper B—open or closed on rod of build material 142. On the x-axis (time) there are 3 key times marked on the axis (times 3, 4, and 5).

The table below describes time intervals for each gripper:

| Event | Description | Gripper A | Gripper B |
|---|---|---|---|
| Resetting | As gripper is travelling near the bottom of travel (A1) | 0-1 | 3-4 |
| | the gripper opens to the open state. Once open the | | |
| | gripper quickly moves to the top of travel (A0) | | |
| Gripping | Gripper starts to move back down to bottom of travel | 1-2 | 4-5 |
| | (A1) from (A0). As gripper is moving downward the | | |
| | gripper then closes, contacting the rod. | | |
| | Gripping can happen while the gripper is paused at | | |
| | (A0), but the lower gripper may also pause. It is | | |
| | advantageous to grip as the carriage is moving | | |
| | downward as to not oppose the other gripper as it is | | |
| | actuating. | | |
| Actuating | As the gripper is in contact with the rod, the gripper | 2-0 | 5-3 |
| | traverses through its range of motion to the bottom of | | |
| | travel (A1) | | |

Although the timing table above and FIG. 23B depict that grippers A and B pause at the bottom of travel as the gripper is opening (during the resetting step), gripper A or B may continue to travel downward as gripper A or B, respectively, is opening.

As shown in FIG. 23B, as gripper A actuates, gripper B resets. At least one of gripper A or gripper B may always be in the actuating state (a closed state, moving downwards). A time to reset (open gripper A or gripper B and move to top of the travel) is small as compared to the actuating time, so as to achieve continuous motion or rod of build material 142. Lateral gripping displacement (an amount arms of gripper A or gripper B move radially inward) may be small as compared to total linear travel of the respective gripper. In an alternative, actuation assembly 2300 may pause as the resetting event takes place for each gripper.

Reloading of actuation assembly 2300 may occur similarly to any of the grippers described above. Gripper arms 2310a, 2310b may open to a position which provides enough space for a maximum cross-sectional are of rod of build material 142 to pass between gripper arms 2310a, 2310b. A longitudinal length of an interface (space) between two successive rods of build material 142 may be equal to or smaller than a longitudinal dimension of gripper arms 2310a, 2310b. Actuation may then continue as if successive rods of build material were a single, solid rod. Actuation of gripper arms 2310a, 2310b relative to gripper arms 2310a, 2310b may be calibrated to ensure that ends of successive rods of build material 142 are always making contact with one another. This may minimize a tendency for air gaps to be introduced.

To account for variations in diameters of rods of build material 142, pairs of gripper arms 2310a, 2310b and/or 2320a, 2320b may travel laterally to generate a specified gripping force, as opposed to moving a prescribed lateral displacement. Allowing pairs of gripper arms 2310a, 2310b and/or 2320a, 2320b to contract varying amounts based on diameter of rod of build material 142 may be accomplished by a variety of methods, including, for example, the methods described with respect to the grippers above. Methods include: pneumatic cylinders, solenoids (magnetic), external motors with torque limiting features, collets, cam systems, vacuum, wire wrapped around a circumference of a rod of build material 142 that can dilate/contract (e.g., nitinol, which may expand or contract with applied current, or a pipe clamp), and/or an inflatable ring (e.g., a donut shaped element which dilates and/or contracts with applied air pressure).

Gripper arms 2310a, 2310b and/or 2320a, 2320b may be opened or closed via any suitable mechanisms, including, for example, lead screws, solenoids (e.g., dual throw solenoids that are forward and back stroke controllable or an electromagnetic attracting anvil with a return spring to bring to top of travel, piezo actuators, voice coil motors, pneumatic cylinders, and/or hydraulic cylinders).

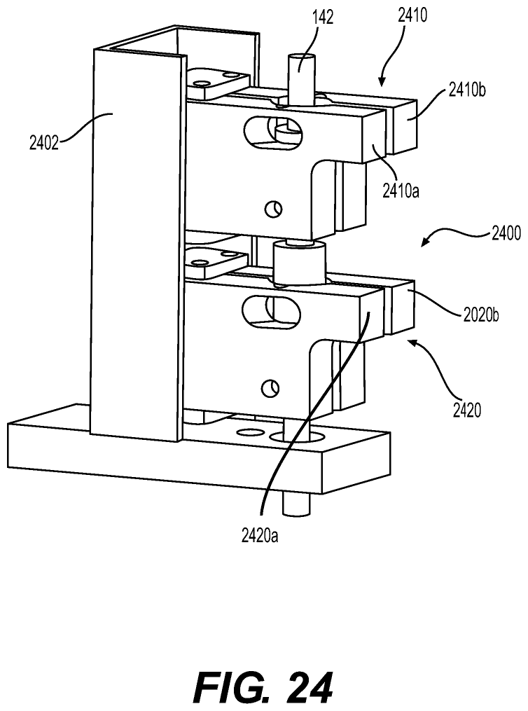

For example, FIG. 24 shows an actuation assembly 2400, which may have any of the properties of actuation assembly 2300. Like reference numbers below have been used where applicable. Actuation assembly 2400 may implement pneumatics to cause actuation along the z-axis. A housing or frame 2402 may house a first gripper 2410, having gripper arms 2410a and 2410b, and a second gripper 2420, having gripper arms 2420a and 2420b. Pneumatics may be utilized in order to move grippers 2410 and 2420. Each of grippers 2410 and 2420 may have its own motor and leadscrew (not labeled but having any of the features of motors and leadscrews described above). Grippers 2410 and 2420 may be actuated along a common linear bearing. Grippers 2410 and 2420 may each be opened and/or closed by at least one pneumatic cylinder

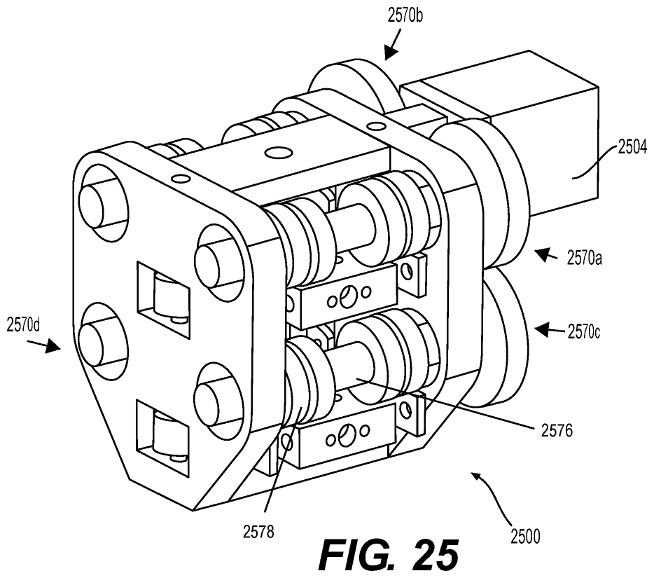

FIG. 25 depicts an exemplary actuation assembly 2500, which may have any of the properties of actuation assemblies 2300, 2400. Actuation assembly 2500 may include four gripper arms, such as those described above with respect to actuation assemblies 2300, 2400. A motor 2504 may power four cam mechanisms 2570a, 2570b, 2570c, 2570d, having spur gears connected to an output gear of motor 2504. Each of cam mechanisms 2570a, 2570b, 2570c, 2570d may have a cam axle 2576. Four hardened steel cams 2578 may be present on each cam axle 2576. The cam profile on each of cams 2578 may generate the gripping, actuating, and resetting motions described above with respect to actuation assembly 2300.

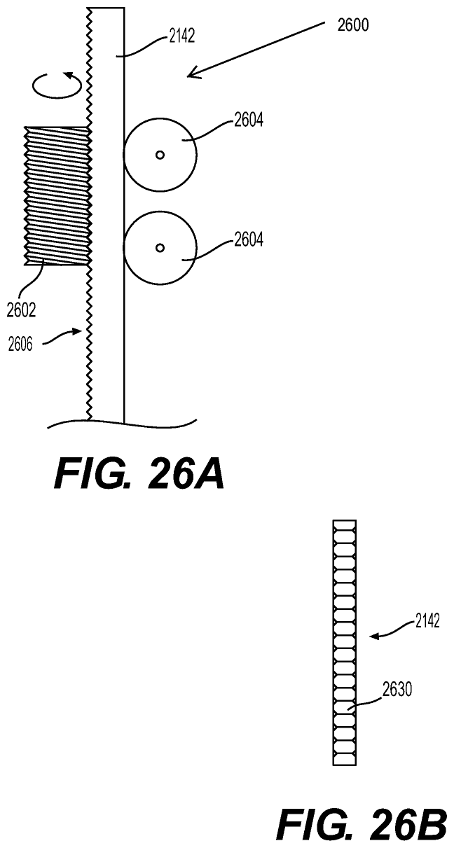

FIG. 26A shows an actuation assembly 2600. Rod of build material 2142 may be driven by one or more helixes 2602 (e.g., rods or worm gears), which are in contact with rod of build material 2142. Helix 2602 may have, for example, helical threads. Helix 2602 may be laterally and longitudinally fixed (only rotatably movable) relative to a frame (not shown). Rod of build material 2142 may be prevented from moving laterally relative to the frame (via, e.g., a support element, as described below). Helix 2602 may contact rod of build material 2142, which may result of indentation into rod of build material 2142 of threads of helix 260. Rotation of helix 2602 may translate to linear displacement of rod of build material 2142.

Helix 2602 may generate pressures/forces which are at least partially parallel to an axis of rod of build material 2142. As helix 2602 is rotating, frictional forces (which are aligned with the x-, y-axes) may tend to cause rod of build material 2142 to rotate rather than translate along the z-axis. Contact pressure parallel to the z-axis (parallel to a longitudinal axis of rod of build material 2142) may be generated only when rod of build material 2142 is forced into helix 2602 and/or mates with molded features present in rod of build material 2142. For example, as shown in FIG. 26B, a rod of build material 2142 may have features 2606 formed thereon that form a structure like that of a rack of gear teeth. These features may be formed in rod of build material 2142 via a heated spur gear which indents into rod of build material 2142. Rod of build material 2142 may be cooled prior to contact with helix 2602.

To generate driving forces along the z-axis, a sufficient lateral preload may be employed to keep the helix 2602 engaged with rod of build material 2142. Therefore, low friction supporting elements may be preset to resist these lateral forces, such as rolling bearings 2604 or a fixed low-friction restraint, similar to those described above. Rotation of rod of build material 2142 may be prevented/minimized by features molded or formed into rod of build material 2142. For example, rod of build material 2142 may have a square, rectangular, or D-shaped cross-section, with a flat face of rod of build material 2142 pressed into supporting elements (e.g., rolling bearings 2604). Actuating helix 2602 may mate with a surface opposite to that facing the supporting element. Additionally or alternatively, a plurality of helixes 2602 may be used, such as in the examples described below.

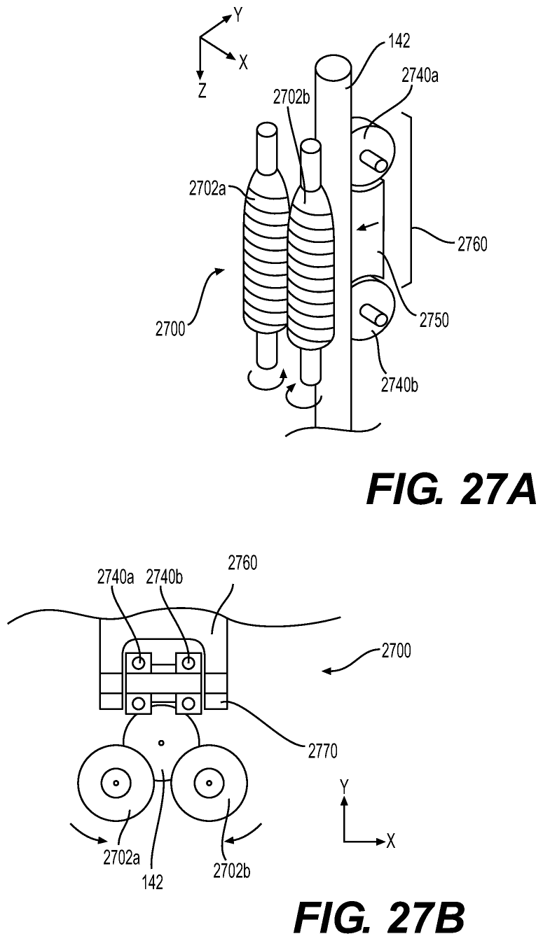

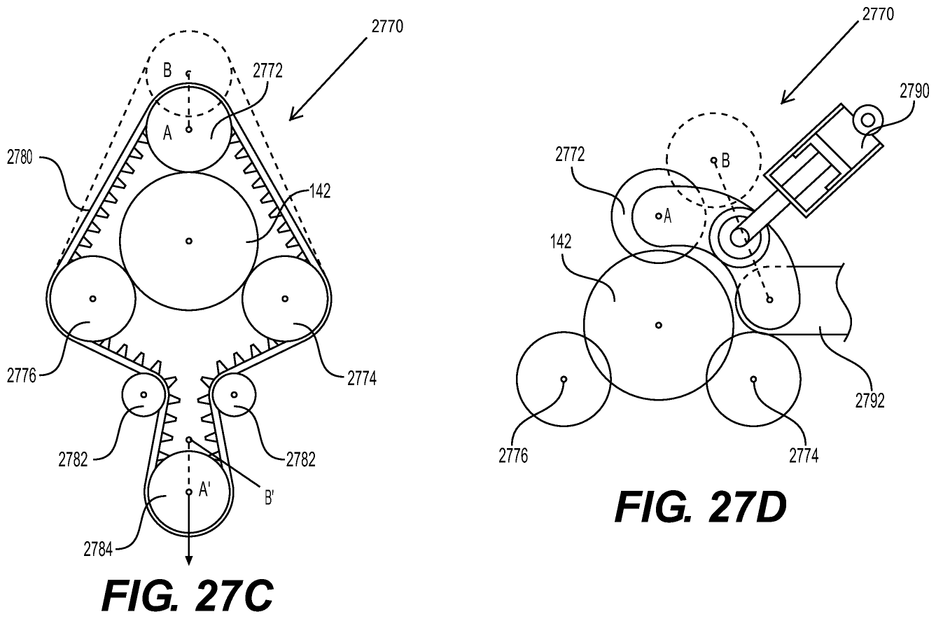

FIGS. 27A and 27B depict an actuation assembly 2700. FIG. 27A shows a perspective view, and FIG. 27B shows a top-down view. Actuation assembly 2700 may include counter-rotating helixes 2702a, 2702b. Torques generated from friction between each of rotating helixes 2702a, 2702b and rod of build material 142 may be cancelled by the counter-rotation of helixes 2702a, 2702b. Helixes 2702a, 2702b may have opposite helix angles so the resultant longitudinal displacement of rod of build material 142 in the z-direction is the same.

Both of rotating helixes 2702a, 2702b may be forced into contact with rod of build material 142 via lateral preload forces, shown by arrows in FIG. 27B. Preload forces into rod of build material 142 may be adjusted manually (may have a fixed distance, adjusted via setscrews or other mechanisms) or set with spring(s) to account for changes in diameter of rod of build material 142 and/or a depth of indentation of helixes 2702a, 2702b into rods of build material 142.

A first pair of support rollers 2740a and a second pair of support rollers 2740b, aligned along the z-axis, may provide alignment (in x- and y-directions) of rod of build material 142. A fixed low-friction restraint 2750 may be disposed between support rollers 2740a, 2740b. Restraint 2750 may provide additional support for when an interface between successive rods of build material 142 passes through the actuation assembly 2700. At most times, there will be no contact between rod(s) of build material 142 and restraint 2750.

Pairs of support rollers 2740a, 2740b may center rod of build material 142 and may dig into rod of build material 142, forming two linear tracks and limiting rotation of rod of build material 142. Pairs of support rollers 2740a, 2740b may alternatively be utilized with the single helix 2602 to inhibit rotation of rod of build material 142.

To facilitate reloading, actuating helixes 2702a, 2702b may have threads on a portion of helixes 2702a, 2702b in the most positive z-direction which taper inwards (i.e., have a smaller diameter). This taper may generate a lead-in angle similar to that described above. This lead-in provides room for the bottom (portion furthest in the negative z-direction) of a rod of build material 142 to drop into the actuating volume. The helical features of helixes 2702a, 2702b then progressively indent/mate with rod of build material 142 and pull it into the actuation assembly 2700.

In an alternative to or in addition to the lead-in, actuation assembly 2700 may be able to open to enable a portion of rod of build material 142 to drop into the actuating volume before re-applying the lateral preload. For example, helixes 2702a, 2702b may be fixed relative to a frame 2760, and support rollers 2740a may move inward and outward to close and open, respectively.

FIGS. 27C and 27D show an alternative actuation assembly 2770. Three helixes 2772, 2774, 2776 may be driven via a timing belt 2780 wrapped around the three helixes 2772, 2774, 2776 Alternatively, timing pulleys may mate with timing belt 2780 and may be attached to the axis of each helix 2772, 2774, 2776. Alterative numbers of helixes (e.g., one helix or more helixes) may be used.

Timing belt 2780 may also wrap around idle pulleys 2782 and a driving pulley 2784. Driving pulley 2784 may be preloaded in the direction shown by the arrow of FIG. 27C in order to provide tension to timing belt 2780. Driving pulley 2784 may be rotated by a motor (not shown) to drive timing belt 2780 about its path.

Helixes 2772, 2774, 2776 may have a lead-in, as described above. Alternatively, actuation assembly 2770 may reload by shifting an axis of helix 2772 from point A to point B, as shown in FIG. 27C. Driving pulley 2784 may move from point A′ to point B′ to provide sufficient slack for helix 2772 to move to the reload position at B, shown by the dotted outline.

FIG. 27D shows an exemplary mechanism for moving helix 2772. A pivot arm 2790 may be attached to a frame 2792, which may also hold helixes 2772, 2774 (and/or helix 2776). A linear actuator 2792 (which may include pneumatics, hydraulics, a solenoid, etc.) may be extended and retracted to move 2772 to point A and point B, respectively. Alternatively, a motor may be used for actuation.

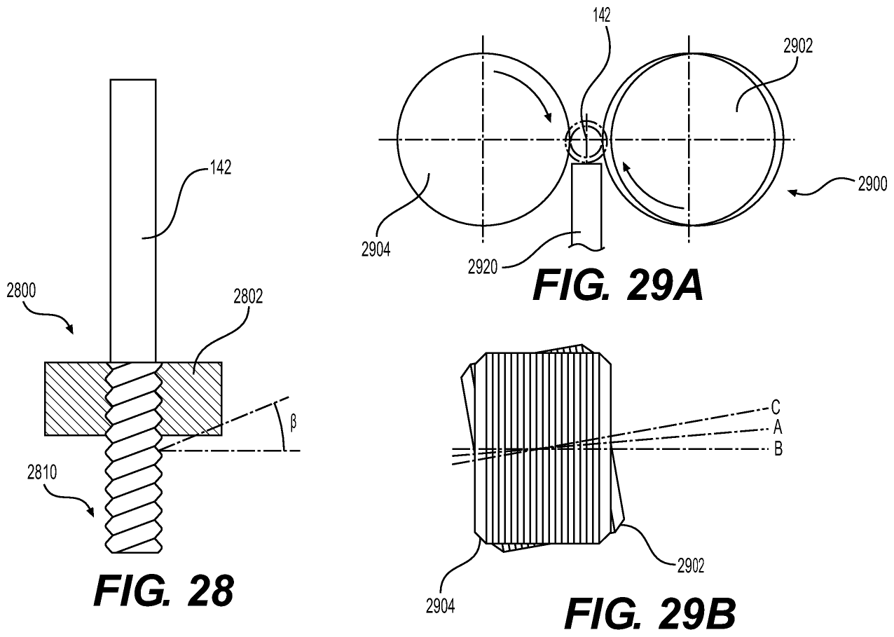

FIGS. 28-35 depict actuation assemblies that use helical structures to generate rotation in rod of build material 142 in order to actuate rod of build material 142. Whereas the actuation assemblies of FIGS. 26 and 27 restrict rotational movement of rod of build material, the examples of FIGS. 28-35 include rotational movement of rod of build material 142. Features of the examples of FIGS. 28-35 may be used in conjunction with features of other examples described herein. Rods of build material 142 used with the examples of FIGS. 28-35 may be (1) indented by the helical features, (2) formed in an extruder prior to contact with the actuators described herein, or (3) pre-molded with external features (e.g., rack, spline, threads, etc.) prior to entering actuators described herein.

FIG. 28 depicts an example actuation assembly 2800 that passes a rod of build material 142 through an inside of a helix. For example, as shown in FIG. 28, actuation assembly 2800 may include a housing 2802 defining an opening defined by threaded surfaces. Alternatively, a tap or other type of hole may be used. Function of actuation assembly 2800 will be discussed further below.

FIG. 29A depicts an example actuation assembly 2900. Actuation assembly 2900 may include a moving die 2902 and a stationary die 2904, and a guide 2920. Rod of build material 142 may be received between moving die 2902 and stationary die 2904. As shown in FIG. 29B, moving die 2902 and stationary die 2904 may have concentric protrusions/indentations formed about circumferences thereof. Rod of build material 142 (not visible between moving die 2902 and stationary die 2904 in FIG. 29B) may have a longitudinal axis A. Moving die may 2902 may have a longitudinal axis C, and stationary die 2904 may have a longitudinal axis B. Moving die 2902 may be skewed relative to stationary die 2904. Both moving die 2902 and stationary die 2904 may have longitudinal axes that are angled relative to the longitudinal axis of rod of build material 142. Alternative numbers of skewed dies may be used (although two are depicted in FIGS. 29A and 29B, one or more skewed dies may be used). One or both of dies 2902, 2904 may function as helixes due to their skews. Operation of actuation assembly 2900 is described below, in conjunction with operation of actuation assembly 2800.

Alternatively, actuation assemblies 2800, 2900 may make use of a Rholix-type gear 3500 (FIG. 35). Rholix gear 3500 may include three bearings, all having an equal angle relative to the z-axis. Because the bearing are at an angle to one another, they form a helix structure.

In both of actuation assemblies 2800, 2900, relative rotational motion between rod of build material 142 and structures of actuation assembly 2800, 2900 may generate linear motion of rod of build material 142 along the z-axis. As shown in FIG. 28, actuation assembly 2800 includes a helix ramp angle β between the helix and the x/y-plane. As housing 2802 rotates relative to rod of build material 142, helix ramp angle β will generate forces along the z-direction which can drive rod of build material 142 up (positive z-direction) or down (negative z-direction), similar to a wood screw going into a deck board (where rod of build material 142 is analogous to the wood screw). With respect to actuation assembly 2900, the longitudinal axis C of moving roller 2902 and the longitudinal axis B of stationary die 2904 may be angled relative to the longitudinal axis of rod of build material 2904. The angle of dies 2902, 2904 may produce forces along the z-axis to drive rod of build material along its longitudinal axis. Housing 2802, moving roller 2902, and/or stationary roller 2904 may be compliant and conform to a surface of rod of build material or may be rigid and indent into rod of build material 142. In both of actuation assemblies 2800 and 2900, rod of build material 142 rotates with respect to the actuation components, because both rotational and z-directional forces are generated.

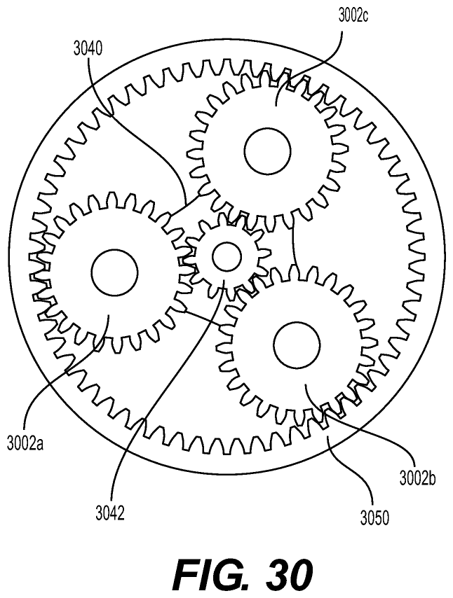

FIG. 30 depicts a planetary gear train 3000, which provides an analogy for the operations of actuation assemblies 2800, 2900. The table below shows the components of gear train 3000, along with analogous structures.

| | Analogous | |
|---|---|---|
| Component | Component | Description/Comments |
| Sun Gear | Rod of build | Rod of build material 142 rotates |
| 3042 | material 142 | relative to actuating helix to move |
| | | in z-direction |
| Planetary | Actuating | Dies 2902, 2904; body 2802; or |
| Pinions 3002a, | Helix | Rholix-type axle 3500 (FIG. 35) |
| 3002b, 3002c | | |
| Planetary | Frame | In some cases, frame can rotate |
| Carrier 3040 | connecting | relative to the extruder frame |
| | all rollers | (Similar to a pencil sharpener) |
| Ring Gear | Method to | Method to drive all helixes, such |
| 3050 | drive (turn) | as a spur gear |
| | all rollers | |

The components above can be used in various combinations of fixed, driven, or idle components. A fixed component does not rotate with respect to the extruder frame. A driven component has rotation controlled via an external source (e.g., a motor). An idle component has rotation that is driven by fixed and/or driven components. For example, if planetary carrier 3040 is fixed, and planetary pinion(s) 3002a, 3002b, 3002c are driven, sun gear 3042 is idle. Sun gear 3042 will be forced to rotate from engagement with planetary pinions 3002a, 3002b, 3002c. This layout may be analogous to actuation assembly 2800.

The table below shows exemplary mechanism permutations. This table outlines the state of each of the components (fixed, driven, idle, N/A). If the component is noted as “N/A,” it is not applicable for the mechanism type. Potential reloading methods for the alternatives are disclosed below

| Alternative | Rod | Roller | Carrier | Example |
|---|---|---|---|---|
| 1 | Fix | Idle | Drive | Pencil sharpener |
| | | | | structure (see FIG. 32, |
| | | | | depicting a pencil |
| | | | | sharpener-type |
| | | | | structure having a helix |
| | | | | 3202 held by a carrier |
| | | | | 3206. Carrier 3206 may |
| | | | | be driven by a structure |
| | | | | such as handle 3204.) |
| 2 | Idle | Driven | Fix | Actuation assembly |
| | | | | 2900 (FIG. 29) |
| 3 | Fix | Driven | Idle | |
| 4 | Driven | Idle | Fix | Rotate rod of build |
| | | | | material 142 into |
| | | | | passive thread roller |
| 5 | Driven | Fix | N/A | Thread rod of build |
| | | | | material 142 into body |
| | | | | 2802 (FIG. 28) |
| 6 | Fix | Drive | N/A | Rotate body 2802 |
| | | | | about fixed rod of build |
| | | | | material (FIG. 28) |

A rod of build material 142 can have its rotation fixed relative to the extruder frame by anti-rotation features which mate with the outer surface of rod of build material (see, e.g., actuation assemblies 2600, 2700). Exemplary anti-rotation features include anti-rotation rollers which dig into rod of build material 142 and/or features molded into rod (e.g., D-shaped cross section, square cross section) which mate with sliding or rolling surfaces.

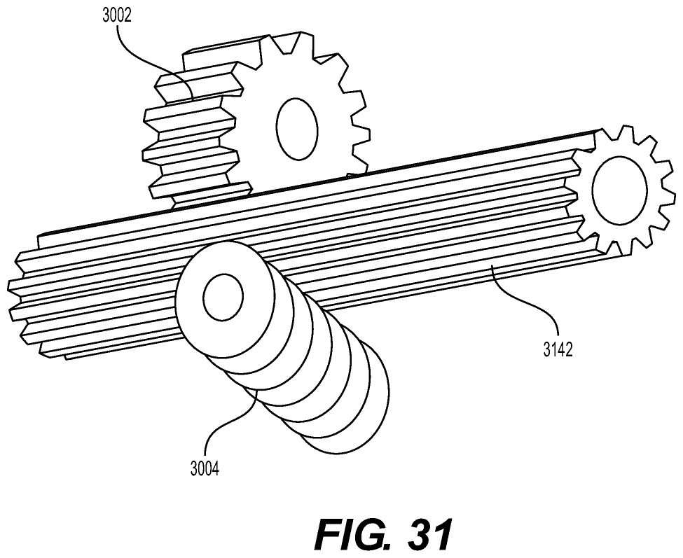

The following are exemplary methods of driving components relative to an extruder frame. With respect to rod of build material 142, rod of build material 142 may be rotated while also allowing rod of build material 142 to move freely along the z-axis. An element may contact an external surface of rod of build material 142 and apply a torque. For example, a collet may grip rod of build material 142 and rotate rod of build material 142 relative to the frame via a motor. The collet may float along the z-axis on a carriage, which travels along a linear bearing. A spline shaft may be used to transfer torque to the rotating collet (or other gripper) along its full travel. In another example, as shown in FIG. 31, spline features may be molded into rod of build material 3142. A driven spur gear 3002 may mate with the spline features. The spur gear may be made with low friction material to minimize resistance to travel of rod of build material 142 along the z-axis. Alternatively, a worm gear 3004 may rotate with the spline features of rod of build material 3142. Although FIG. 31 depicts both spur gear 3002 and worm gear 3004, only one or the other may be required.

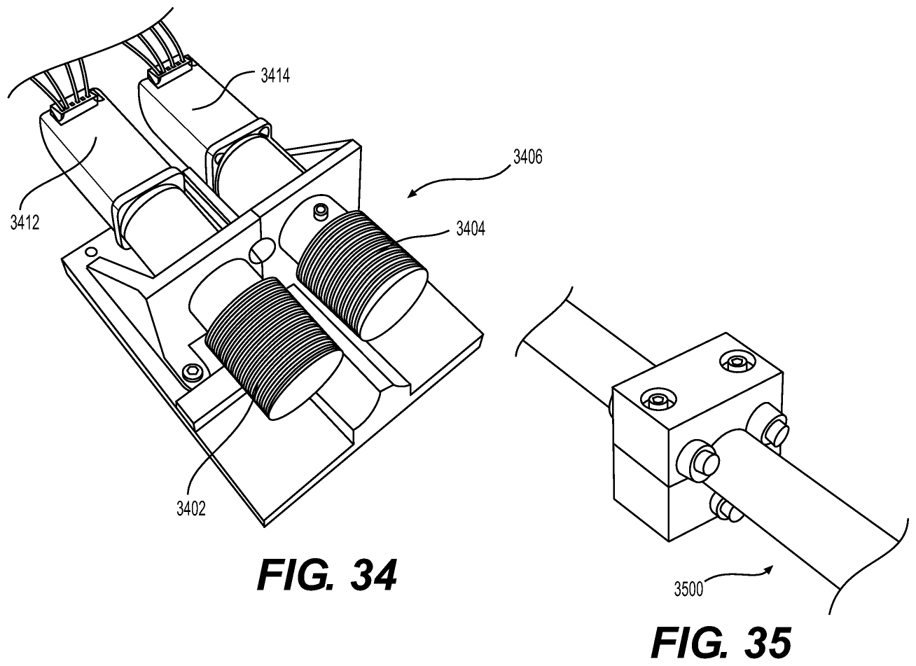

With respect to helix structures (e.g., body 2802 or dies 2902, 2904) corresponding to planetary pinions 3002a, 3002b, 3002c, where a plurality of helixes are used, each helix may be rotated synchronously. A belt (like the belts described above) may be wrapped around a pulley attached to each helix. Alternatively, a ring gear (e.g., ring gear 3050) may be in contact with each helix. Alternatively, a single motor may be used to drive each helix. For example, FIG. 34 shows an actuation assembly 3400 having two dies 3402, 3404 (which may be angled to produce a helix structure). Dies 3402, 3404 may be driven by motors 3412, 3414, respectively. Motor axes defined by motors 3412, 3414 may form oblique angles relative to the z-axis.

With respect to a carrier, like carrier 3040 (FIG. 30), the carrier may be rotated with a motor. An exterior surface of the carrier may include a gear (e.g., a spur gear) so that torque may be transferred from worm gear or spur gear which is driven by a motor. For example, as shown in FIG. 31,

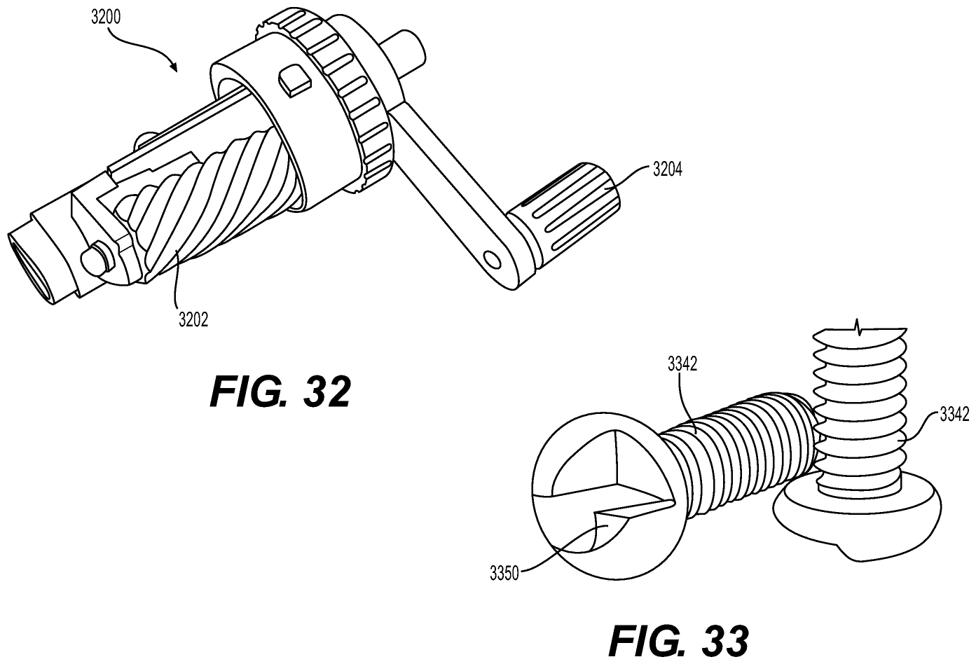

A reloading mechanism for actuation assemblies 2800, 2900, or other actuation mechanisms using the helix mechanisms described in the table above may depend upon a state of rod of build material 142 (idle, fixed, or driven). An idle rod of build material 142 may be reloaded according to any mechanism described above (e.g., a lead-in or having a portion of the actuation assembly open or close to allow rod of build material 142 to drop in).

Where rod of build material 142 is fixed, it may be desirable to ensure that rod of build material 142 is rotatably fixed both upstream and downstream of helix structures. This may be desirable, for example, because if the rotation of rod of build material 142 is not fixed downstream of the helix, rod of build material 142 may not translate along the z-axis once it disengages with an anti-rotation feature upstream of the helix. Therefore, when a subsequent rod of build material 142 drops into the actuation mechanism, it may be blocked by the previous rod of build material 142, which can no longer be actuated.

Where a rod of build material 142 is driven, if there are no features to transfer rotation between two successive rods of build material 142, both rods of build material 142 are synchronously rotated upstream and downstream of the helix structure. As shown in FIG. 33, rod of build material 142 may include mating features 3350 on either end of rod of build material 142, providing for mating between successive rod of build material 142. Such mating features 3350 may be, for example, molded. As shown in FIG. 33, threads 3342 may further facilitate actuation, as described above. Where features, such as mating features 3350, are present, rod of build material 142 may only require actuation upstream of the helix(es). Additionally or alternatively, ends of rods of build material 142 may be melted together and solidified to promote transfer of torque between successive rods of build material 142.

Although one (actuation assembly 2800) or two (actuation assembly 2900) helix structures are shown and described in FIGS. 28 and 29, three or more bearings/helixes may be used. The bearings may be oriented at oblique angles relative to the z-axis in order to generate an effective helix. The rollers can (1) mate with features molded into rod of build material 142 or (2) progressively indent as rod of build material 142 is driven into the rollers. Alternatively, the rollers may be compliant to make local contact with the rod. Such an arrangement may be useful in particular where the rollers are fixed or idle.

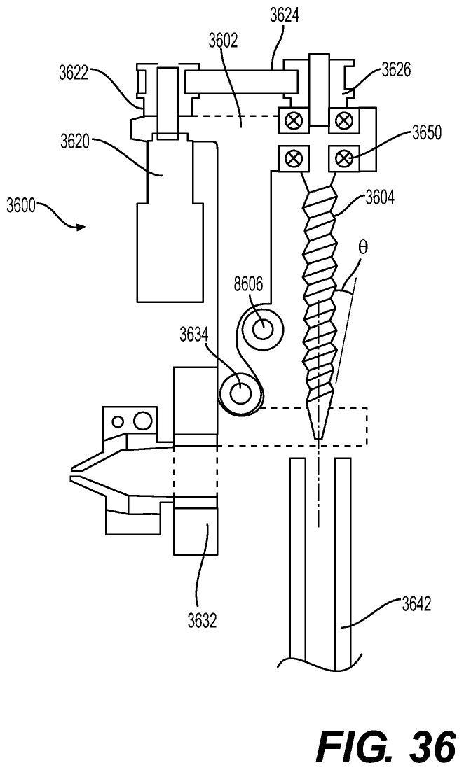

FIG. 36 depicts an example actuation assembly 3600, having a frame 3602 holding components of actuation assembly 3600. A rod of build material 3642 may have a longitudinal opening formed therein (e.g., a donut-shaped cross section). A tap 3604 may have a helical outer surface (e.g., like a screw or a drill bit). Tap 3604 may thread into an inner diameter of rod of build material 3642. Tap 3604 may rotate, and rod of build material 3642 may be rotationally fixed. For example, anti-rotation rollers (such as those described above with respect to FIG. 26A) may be utilized. Tap 3604 may have a tapered tip at an end furthest in the negative z-direction. The tip may be tapered at an angle θ relative to the z-axis. The tapered tip may provide for a lead-in during reloading.

Tap 3604 may be driven (rotated) via a timing belt 3624 and pulleys 3622 connected to a shaft of motor 3620. To reload a new rod of build material 3642, extrusion head 3632 may pivot about pivot axis 3634from the position represented in dashed lines to the position shown in solid lines, in order to allow a new rod of build material 3642 to be inserted on tapered portion of tap 3604. Once rod of build material 3642 has been placed fully onto tap 3604, extrusion head 3632 may pivot from the position shown in solid lines in FIG. 36 to the position represented in dashed lines in FIG. 36 in order to begin extruding again.

While principles of the present disclosure are described herein with reference to illustrative examples for particular applications, it should be understood that the disclosure is not limited thereto. Those having ordinary skill in the art and access to the teachings provided herein will recognize additional modifications, applications, and substitution of equivalents all fall within the scope of the examples described herein. Accordingly, the invention is not to be considered as limited by the foregoing description.

We claim:

1. An actuation method, the method comprising:
applying a force to a first rod of build material disposed within an actuation volume, wherein the first rod of build material includes at least one metal;
moving the first rod of build material in a direction substantially parallel to or substantially coaxial with a longitudinal axis of the first rod of build material toward an extrusion head;
loading a second rod of build material into the actuation volume, wherein the second rod of build material includes at least one metal, and wherein a longitudinal axis of the second rod is substantially coaxial with the longitudinal axis of the first rod; and
repeating the applying step and the moving step to the second rod of build material.

2. The method of claim 1, wherein the force is applied by a body to an end surface of the first rod or the second rod, and wherein, prior to the loading step, the body rotates about an axis perpendicular to or parallel to the longitudinal axis of the first rod or the second rod.

3. The method of claim 1, wherein the actuation volume is defined by a tube and, wherein, prior to the loading step, the tube is moved relative to the extrusion head.

4. The method of claim 1, wherein the wherein the force is applied by a body to an end surface of the first rod or the second rod, and wherein the body is driven by at least one of pneumatic pressure or a ballista.

5. The method of claim 1, wherein the force includes a component that is perpendicular to the longitudinal axis of the first rod or the second rod, and wherein the force is applied by at least two structures.

6. The method of claim 5, wherein at least one of the two structures is an arm pivotable about an axis that is parallel to the longitudinal axis of the first rod or the second rod or is translatable in a direction perpendicular to the longitudinal axis of the first rod or the second rod.

7. The method of claim 5, wherein the force is applied by a first pair of arms and a second pair of arms, downstream of the first pair of arms.

8. The method of claim 7, wherein, during the applying the force step, in a first configuration, the first pair of arms is in a closed state and the second pair of arms is in a closed state and, in a second configuration, the first pair of arms is in the closed state and the second pair of arms is in an open state.

9. The method of claim 1, wherein the actuation volume is a first actuation volume, and the force is a first force, the method further comprising:
applying a second force to a third rod of build material disposed within a second actuation volume, wherein the third rod of build material includes at least one metal, and wherein a longitudinal axis of the third rod is parallel to but not coaxial with the longitudinal axis of the first rod.

10. The method of claim 1, wherein the force causes grooves to be formed in the first rod or wherein each of the first rod and the second rod includes grooves preformed thereon prior to the force being applied.

11. The method of claim 1, wherein the force is applied by a belt or a tread disposed about at least one pulley.

12. The method of claim 10, wherein a worm gear exerts a force on the belt or the tread.

13. The method of clam 1, wherein the force is exerted by at least one rotating helix.

14. The method of claim 13, wherein, while the force is applied to the first rod or the second rod, the respective first rod or second rod rotates with respect to the extrusion head.

15. The method of claim 1, wherein each of the first rod and the second rod defines a central opening, and wherein the force is exerted via a tap inserted into the central opening.

16. An actuation method, the method comprising:
using a body, applying a first force to a first rod of build material disposed within a first actuation volume, wherein the first rod of build material includes at least one metal;
moving the first rod of build material in a direction substantially parallel to or substantially coaxial with a longitudinal axis of the first rod of build material toward an extrusion head;
moving at least one of the body or the first actuation volume so that the at least one of the body or the first actuation volume does not intersect a longitudinal axis of the extrusion head;
using the body, applying a second force to a second rod of build material disposed within a second actuation volume, wherein the second rod of build material includes at least one metal; and
moving the second rod of build material in a direction substantially parallel to or substantially coaxial with the longitudinal axis of the second rod toward the extrusion head.

17. The method of claim 16, wherein the first actuation volume is the same as the second actuation volume.

18. The method of claim 16, wherein the first actuation volume is defined by a first tube, and wherein the second actuation volume is defined by a second tube.

19. An actuation method, the method comprising:
simultaneously applying a first force to a first rod of build material and a second force to a second rod of build material, wherein each of the first rod and the second rod includes metal; and
simultaneously moving the first rod along a longitudinal axis of the first rod and the second rod along a longitudinal axis of the second rod.

20. The method of claim 19, wherein the moving step causes each of the first rod and the second rod to move toward a single extrusion head.
